(19) United States
(12) Patent Application Publication
(10) Pub. No.: US 2026/0187850 A1
(43) Pub. Date: Jul. 2, 2026

(54) HETEROGENEOUS MESH AUTOENCODERS

(71) Applicant: InterDigital VC Holdings, Inc., Wilmington, DE (US)

(72) Inventors: Eric Lei, Philadelphia, PA (US); Muhammad Asad Lodhi, Highland Park, NJ (US); Jiahao Pang, Plainsboro, NJ (US); Junghyun Ahn, New York, NY (US); Dong Tian, Boxborough, MA (US)

(21) Appl. No.: 19/127,642

(22) PCT Filed: Nov. 9, 2023
(86) PCT No.: PCT/US2023/079252

§ 371 Date: May 6, 2025

Related U.S. Application Data
(60) Provisional application No. 63/424,421, filed on Nov. 10, 2022.
(60) Provisional application No. 63/463,747, filed on May 3, 2023.

(51) Int. Cl. G06T 9/00; G06T 17/20; H04N 19/597

(52) U.S. Cl. CPC G06T 9/001; G06T 9/002; G06T 17/20; H04N 19/597

(57) ABSTRACT

Some embodiments of a method may include: accessing a semi-regular input mesh to generate an initial mesh face feature for each mesh face, wherein the semi-regular input mesh comprises a face list and a plurality of vertex positions; generating a base mesh comprising vertex positions and information indicating a base connectivity, along with a set of face features on the base mesh, through a learning-based feature aggregation module; generating a fixed-length codeword based on base face features using a feature pooling module; accessing a predefined template mesh and the base mesh to generate a set of matching indices comprising indices of information indicating matched vertices between the predefined template mesh and the base mesh; and outputting the generated fixed-length codeword, and the information indicating the base connectivity.

### CROSS-REFERENCE TO RELATED APPLICATIONS

The present application is an international application, which claims benefit under 35 U.S.C. § 119(e) from U.S. Provisional Patent Application Ser. No. 63/424,421, entitled “HETEROGENEOUS MESH AUTOENCODERS” and filed Nov. 10, 2022, and from U.S. Provisional Patent Application Ser. No. 63/463,747, entitled “LEARNING BASED HETEROGENEOUS MESH AUTOENCODERS” and filed May 3, 2023, each of which is hereby incorporated by reference in its entirety.

### INCORPORATION BY REFERENCE

The present application further incorporates by reference in their entirety the following applications: International Application No. PCT/US2021/034400, entitled “METHODS, APPARATUS AND SYSTEMS FOR GRAPH-CONDITIONED AUTOENCODER (GCAE) USING TOPOLOGY-FRIENDLY REPRESENTATIONS” and filed May 27, 2021 (“400 application”), which claims benefit under 35 U.S.C. § 119 (e) from U.S. Provisional Patent Application Ser. No. 63/047,446, entitled “METHODS, APPARATUS AND SYSTEMS FOR GRAPH-CONDITIONED AUTOENCODER (GCAE) USING TOPOLOGY-FRIENDLY REPRESENTATIONS” and filed Jul. 2, 2020; which are hereby incorporated by reference in their entirety.

### BACKGROUND

Point Cloud (PC) data format is a universal data format across several business domains, e.g., autonomous driving, robotics, augmented reality/virtual reality (AR/VR), civil engineering, computer graphics, and the animation/movie industry. 3D LiDAR (Light Detection and Ranging) sensors have been deployed in self-driving cars, and affordable LiDAR sensors are available. With advances in sensing technologies, 3D point cloud data becomes more practical than ever.

### SUMMARY

Embodiments described herein include methods that are used in video encoding and decoding (collectively “coding”).

A first example method in accordance with some embodiments may include: accessing a semi-regular input mesh to generate an initial mesh face feature for each mesh face, wherein the semi-regular input mesh comprises a face list and a plurality of vertex positions; generating a base mesh comprising vertex positions and information indicating a base connectivity, along with a set of face features on the base mesh, through a learning-based feature aggregation module; generating a fixed-length codeword based on base face features using a feature pooling module; accessing a predefined template mesh and the base mesh to generate information indicating matched vertices between the predefined template mesh and the base mesh; and outputting the generated fixed-length codeword and the information indicating the base connectivity.

A second example method in accordance with some embodiments may include: accessing an input remeshed mesh to generate initial mesh face features, wherein the input remeshed mesh comprises a face list and vertex positions; generating a base mesh along with a set of face features map on the base mesh; generating a fixed length codeword from the base face features; accessing a predefined sphere mesh of predefined number of vertices and base mesh vertices to generate a matching between the sphere mesh vertices and the base mesh vertices; and outputting the generated fixed length codeword and base mesh connectivity information.

A third example method in accordance with some embodiments may include: accessing an input mesh, wherein the input mesh comprises a face list and a plurality of vertex positions; generating at least two initial mesh face features for at least one face listed on the face list of the input mesh; generating a base mesh and at least two base mesh face features on the base mesh, wherein the base mesh comprises vertex positions and information indicating a base mesh connectivity; generating a fixed-length codeword from the at least two base mesh face features; accessing a predefined template mesh; generating information indicating matched vertices between the predefined template mesh and the base mesh; and outputting the fixed-length codeword and the information indicating the base mesh connectivity.

For some embodiments of the third example method, the input mesh is a semi-regular mesh.

For some embodiments of the third example method, generating the base mesh may include:
generating the vertex positions; and generating the information indicating the base mesh connectivity.

For some embodiments of the third example method, generating the at least two base mesh face features on the base mesh is performed through a learning-based aggregation of the at least two initial mesh face features.

For some embodiments of the third example method, generating the fixed-length codeword is performed by pooling of the at least two base mesh face features.

For some embodiments of the third example method, the predefined template mesh is a mesh corresponding to a unit sphere.

For some embodiments of the third example method, the information indicating the base connectivity comprises a list of triangles with information indicating indexing corresponding to matching vertices indicated by the set of matching indices

For some embodiments of the third example method, generating the base mesh and at least two base mesh face features on the base mesh is performed by a learning-based heterogeneous mesh encoder, and the heterogeneous mesh encoder comprises at least one down-sampling face convolutional layer.

For some embodiments of the third example method, generating the fixed-length codeword from the at least two base mesh face features comprises using a learning-based AdaptMaxPool process.

For some embodiments of the third example method, generating the set of matching indices is performed through a learning-based SphereNet process.

Some embodiments of the third example method may further include: outputting the information indicating matched vertices, wherein the information indicating matched vertices comprises a set of matching indices indicating matched vertices between the predefined template mesh and the base mesh.

A first example apparatus in accordance with some embodiments may include: a processor; a memory, the memory storing instructions operative, when executed by the processor, to cause the mesh encoder to: access a semi-regular input mesh to generate an initial mesh face feature for each mesh face, wherein the semi-regular input mesh comprises a face list and a plurality of vertex positions; generate a base mesh comprising vertex positions and information indicating a base connectivity, along with a set of face features on the base mesh, through a learning-based feature aggregation module; generate a fixed-length codeword based on base face features using a feature pooling module; access a predefined template mesh and the base mesh to generate information indicating matched vertices between the predefined template mesh and the base mesh; and output the generated fixed-length codeword and the information indicating the base connectivity.

A second example apparatus in accordance with some embodiments may include: a processor; and a memory, the memory storing instructions operative, when executed by the processor, to cause the processor to: access an input remeshed mesh to generate initial mesh face features, wherein the input remeshed mesh comprises a face list and vertex positions; generate a base mesh along with a set of face features map on the base mesh; generate a fixed length codeword from the base face features; access a predefined sphere mesh of predefined number of vertices and base mesh vertices to generate matching between the sphere mesh vertices and the base mesh vertices; and output the generated fixed length codeword and base mesh connectivity information.

A third example apparatus in accordance with some embodiments may include: a processor; a memory, the memory storing instructions operative, when executed by the processor, to cause the mesh encoder to: access an input mesh, wherein the input mesh comprises a face list and a plurality of vertex positions; generate at least two initial mesh face features for at least one face listed on the face list of the input mesh; generate a base mesh and at least two base mesh face features on the base mesh, wherein the base mesh comprises vertex positions and information indicating a base mesh connectivity; generate a fixed-length codeword from the at least two base mesh face features; access a predefined template mesh; generate information indicating a matching of vertices between the predefined template mesh and the base mesh; and output the fixed-length codeword and the information indicating the base mesh connectivity.

A fourth example method in accordance with some embodiments may include: accessing a base connectivity information and a predefined sphere mesh to generate, through a learning-based module DeSphereNet, a reconstructed base mesh along with a base face feature map; and generating K reconstructed meshes at K hierarchical resolutions through a learning-based module HetMeshDec, consisting of a series of K pairs of UpFaceConv and Face2Node modules.

A fifth example method in accordance with some embodiments may include: accessing base mesh connectivity information, a fixed length codeword, and a predefined sphere mesh to generate a reconstructed base mesh along with a base face feature map; and generating K reconstructed meshes at K hierarchical resolutions.

A sixth example method in accordance with some embodiments may include: receiving a fixed-length codeword, information indicating base mesh connectivity, and a predefined mesh to generate a reconstructed base mesh and at least two base face features; generating a reconstructed base mesh and at least two base face features; and generating at least one reconstructed mesh for at least two hierarchical resolutions.

For some embodiments of the sixth example method, generating the at least one reconstructed mesh generates K reconstructed meshes for K hierarchical resolutions.

For some embodiments of the sixth example method, generating K reconstructed meshes is generated using a heterogeneous mesh decoder.

For some embodiments of the sixth example method, the heterogeneous mesh decoder performs at least one up-sampling face convolution process and at least one Face2Node process.

For some embodiments of the sixth example method, generating the at least one reconstructed mesh generates at least two reconstructed meshes for at least two respective hierarchical resolutions.

For some embodiments of the sixth example method, generating the reconstructed base mesh is performed through a learning-based DeSphereNet process.

For some embodiments of the sixth example method, generating the at least one reconstructed mesh for at least two hierarchical resolutions comprises: determining input face features from the base face feature map; generating updated face features corresponding to the input face features; determining an updated differential position for one or more nodes of the reconstructed mesh; and updating a position of one or more nodes of the reconstructed base mesh using the respective updated differential position.

A fourth example apparatus in accordance with some embodiments may include: a processor; a memory, the memory storing instructions operative, when executed by the processor, to cause the mesh decoder to: access a base connectivity information and a predefined sphere mesh to generate, through a learning-based module DeSphereNet, a reconstructed base mesh along with a base face feature map; and generate K reconstructed meshes at K hierarchical resolutions through a learning-based module HetMeshDec, consisting of a series of K pairs of UpFaceConv and Face2Node modules.

A fifth example apparatus in accordance with some embodiments may include: a processor; and a memory, the memory storing instructions operative, when executed by the processor, to cause the processor to: access base mesh connectivity information, a fixed length codeword, and a predefined sphere mesh to generate, a reconstructed base mesh along with a base face feature map; and generate K reconstructed meshes at K hierarchical resolutions.

A sixth example apparatus in accordance with some embodiments may include: a processor; a memory, the memory storing instructions operative, when executed by the processor, to cause the mesh decoder to: receive a fixed-length codeword, information indicating base mesh connectivity, and a predefined mesh to generate a reconstructed base mesh and at least two base face features; generate a reconstructed base mesh and at least two base face features; and generate at least one reconstructed mesh for at least two hierarchical resolutions.

An example mesh decoder configured to take a fixed length codeword, base connectivity information, and a set of sphere matching indices, and to generate a reconstructed mesh in accordance with some embodiments may be configured to: access the base connectivity information and the predefined sphere mesh to generate, through a learning-based module DeSphereNet, a reconstructed base mesh along with a base face feature map; and generate K reconstructed meshes at K hierarchical resolutions through a learning-based module HetMeshDec, consisting of a series of K pairs of UpFaceConv and Face2Node modules.

A seventh example method in accordance with some embodiments may include: determining initial mesh face features from an input mesh; determining a base mesh comprising a set of face features based on a first learning-based module, comprising a series of mesh feature extraction layers; generating a fixed length codeword from the base mesh using a second learning-based pooling module over the mesh faces; and, generating a base graph by matching the vertices of a predefined template mesh and vertices of the base mesh using a third module.

A seventh example apparatus in accordance with some embodiments may include: memory and a processor, configured to perform: determining initial mesh face features from an input mesh; determining a base mesh comprising a set of face features based on a first learning-based module, comprising a series of mesh feature extraction layers; generating a fixed length codeword from the base mesh using a second learning-based pooling module over the mesh faces; and, generating a base graph by matching the vertices of a predefined template mesh and vertices of the base mesh using a third module.

An eighth example method in accordance with some embodiments may include: determining a reconstructed base mesh and base face feature map via a first learning based module using a fixed codeword and base graph in presence of the predefined template mesh; generating at least one reconstructed mesh at a plurality of hierarchical resolutions through a second learning-based module comprising a series of layers comprising a series of mesh feature extraction and node generation layers.

An eighth example apparatus in accordance with some embodiments may include: memory and a processor, configured to perform: determining a reconstructed base mesh and base face feature map via a first learning based module using a fixed codeword and base graph in presence of the predefined template mesh; generating at least one reconstructed mesh at a plurality of hierarchical resolutions through a second learning-based module comprising a series of layers comprising a series of mesh feature extraction and node generation layers.

A ninth example apparatus in accordance with some embodiments may include: a heterogeneous mesh encoder comprising a series of layers comprising pairs of a mesh feature extraction module and a mesh downsampling module; and a heterogeneous mesh decoder comprising a learning-based module comprising a series of layers comprising pairs of a mesh node generation module, and a mesh upsampling module.

For some embodiments of the ninth example apparatus, a base mesh is transmitted from the heterogeneous mesh encoder to the heterogeneous mesh decoder.

For some embodiments of the ninth example apparatus, a plurality of input features are used in addition to a mesh directly consumed.

For some embodiments of the eighth example method, said loop subdivision-based upsampling module comprises: constructing a set of augmented node-specific face features; updating said set of augmented node-specific face features using a shared module; averaging the updated node-specific face features; and performing neighborhood averaging on node locations.

Some embodiments of the eighth example method may further include: converting a codeword into a set of face-specific codewords; and transforming the face-specific codewords into base mesh features and geometry.

Some embodiments of the eighth example method may further include: converting a raw mesh into partitions; shifting the origin for said partitions; and, encoding or decoding each partition mesh separately.

For some embodiments of the eighth example method, said meshes are of differing sizes and connectivity.

A tenth example apparatus in accordance with some embodiments may include a non-transitory computer readable medium containing data content generated according to any one of the methods listed above for playback using a processor.

A first example signal in accordance with some embodiments may include: video data generated according to any one of the methods listed above for playback using a processor.

An example computer program product in accordance with some embodiments may include instructions which, when the program is executed by a computer, cause the computer to carry out any one of the methods listed above.

A first non-transitory computer readable medium in accordance with some embodiments may include data content comprising instructions to perform any one of the methods listed above.

For some embodiments of the seventh example apparatus, said third module is a learning based module.

For some embodiments of the seventh example apparatus, said third module is a traditional non-learning based module.

An eleventh example method in accordance with some embodiments may include: accessing an input mesh, wherein the input mesh comprises a face list and a plurality of vertex positions; generating at least two initial mesh face features for at least one face listed on the face list of the input mesh; generating a base mesh and at least two base mesh face features on the base mesh, wherein the base mesh comprises vertex positions and information indicating a base mesh connectivity; accessing a predefined template mesh; generating information indicating matched vertices between the predefined template mesh and the base mesh; and outputting the information indicating the base mesh connectivity.

An eleventh example apparatus in accordance with some embodiments may include: a processor; and a memory, the memory storing instructions operative, when executed by the processor, to cause the processor to: access an input mesh, wherein the input mesh comprises a face list and a plurality of vertex positions; generate at least two initial mesh face features for at least one face listed on the face list of the input mesh; generate a base mesh and at least two base mesh face features on the base mesh, wherein the base mesh comprises vertex positions and information indicating a base mesh connectivity; access a predefined template mesh; generate information indicating matched vertices between the predefined template mesh and the base mesh; and output the information indicating the base mesh connectivity.

A twelfth example method in accordance with some embodiments may include: receiving information indicating base mesh connectivity, and a predefined mesh to generate a reconstructed base mesh and at least two base face features; generating a reconstructed base mesh and at least two base face features; and generating at least one reconstructed mesh for at least two hierarchical resolutions.

A twelfth example apparatus in accordance with some embodiments may include: a processor; and a memory, the memory storing instructions operative, when executed by the processor, to cause the processor to: receive information indicating base mesh connectivity, and a predefined mesh to generate a reconstructed base mesh and at least two base face features; generate a reconstructed base mesh and at least two base face features; and generate at least one reconstructed mesh for at least two hierarchical resolutions.

A thirteenth example method in accordance with some embodiments may include: accessing an input mesh, wherein the input mesh comprises a face list and a plurality of vertex positions; performing a heterogeneous mesh encoder process to generate at least two initial mesh face features for at least one face listed on the face list of the input mesh; performing an AdaptMaxPool process to: generate a base mesh and at least two base mesh face features on the base mesh, wherein the base mesh comprises vertex positions and information indicating a base mesh connectivity; and generate a fixed-length codeword from the at least two base mesh face features; outputting the fixed-length codeword and the information indicating the base mesh connectivity.

A thirteenth example apparatus in accordance with some embodiments may include: a processor; and a memory, the memory storing instructions operative, when executed by the processor, to cause the processor to: access an input mesh, wherein the input mesh comprises a face list and a plurality of vertex positions; perform a heterogeneous mesh encoder process to generate at least two initial mesh face features for at least one face listed on the face list of the input mesh; perform an AdaptMaxPool process to: generate a base mesh and at least two base mesh face features on the base mesh, wherein the base mesh comprises vertex positions and information indicating a base mesh connectivity; and generate a fixed-length codeword from the at least two base mesh face features; outputting the fixed-length codeword and the information indicating the base mesh connectivity.

A fourteenth example method in accordance with some embodiments may include: receiving a fixed-length codeword, information indicating base mesh connectivity, and a predefined mesh to generate a reconstructed base mesh and at least two base face features; performing a Base Mesh Reconstruction Graph

Neural Network (BaseConGNN) process to generate a reconstructed base mesh and at least two base face features; and performing a heterogeneous mesh decoder process to generate at least one reconstructed mesh for at least two hierarchical resolutions.

A fourteenth example apparatus in accordance with some embodiments may include: a processor; and a memory, the memory storing instructions operative, when executed by the processor, to cause the processor to: receive a fixed-length codeword, information indicating base mesh connectivity, and a predefined mesh to generate a reconstructed base mesh and at least two base face features; perform a Base Mesh Reconstruction Graph Neural Network (BaseConGNN) process to generate a reconstructed base mesh and at least two base face features; and perform a heterogeneous mesh decoder process to generate at least one reconstructed mesh for at least two hierarchical resolutions.

A fifteenth example method in accordance with some embodiments may include: accessing an input mesh; partitioning the input mesh into a first input mesh and a second input mesh, wherein the first input mesh comprises a first face list and a first plurality of vertex positions, and wherein the second input mesh comprises a second face list and a second plurality of vertex positions; generating at least two first initial mesh face features for at least one first face listed on the first face list of the first input mesh; generating a first base mesh and at least two first base mesh face features on the first base mesh, wherein the first base mesh comprises first vertex positions and first information indicating a first base mesh connectivity; generating a first fixed-length codeword from the at least two first base mesh face features; accessing a first predefined template mesh; outputting the first fixed-length codeword and the first information indicating the first base mesh connectivity; generating at least two second initial mesh face features for at least one second face listed on the second face list of the second input mesh; generating a second base mesh and at least two second base mesh face features on the second base mesh, wherein the second base mesh comprises second vertex positions and second information indicating a first base mesh connectivity; generating a second fixed-length codeword from the at least two second base mesh face features; accessing a second predefined template mesh; and outputting the second fixed-length codeword and the second information indicating the second base mesh connectivity.

Some embodiments of the fifteenth example method may further include: generating a first set of matching indices, wherein the first set of matching indices indicates first matched vertices between the first predefined template mesh and the first base mesh; outputting the first set of matching indices; generating a second set of matching indices, wherein the second set of matching indices indicates second matched vertices between the second predefined template mesh and the second base mesh; and outputting the second set of matching indices.

A fifteenth example apparatus in accordance with some embodiments may include: a processor; and a memory, the memory storing instructions operative, when executed by the processor, to cause the processor to: access an input mesh; partition the input mesh into a first input mesh and a second input mesh, wherein the first input mesh comprises a first face list and a first plurality of vertex positions, and wherein the second input mesh comprises a second face list and a second plurality of vertex positions; generate at least two first initial mesh face features for at least one first face listed on the first face list of the first input mesh; generate a first base mesh and at least two first base mesh face features on the first base mesh, wherein the first base mesh comprises first vertex positions and first information indicating a first base mesh connectivity; generate a first fixed-length codeword from the at least two first base mesh face features; access a first predefined template mesh; output the first fixed-length codeword and the first information indicating the first base mesh connectivity; generate at least two second initial mesh face features for at least one second face listed on the second face list of the second input mesh; generate a second base mesh and at least two second base mesh face features on the second base mesh, wherein the second base mesh comprises second vertex positions and second information indicating a first base mesh connectivity; generate a second fixed-length codeword from the at least two second base mesh face features; access a second predefined template mesh; and output the second fixed-length codeword and the second information indicating the second base mesh connectivity.

A sixteenth example apparatus in accordance with some embodiments may include: at least one processor configured to perform any one of the methods listed above.

A seventeenth example apparatus in accordance with some embodiments may include a computer-readable medium storing instructions for causing one or more processors to perform any one of the methods listed above.

An eighteenth example apparatus in accordance with some embodiments may include: at least one processor and at least one non-transitory computer-readable medium storing instructions for causing the at least one processor to perform any one of the methods listed above.

A second example signal in accordance with some embodiments may include: a bitstream generated according to any one of the methods listed above.

In additional embodiments, encoder and decoder apparatus are provided to perform the methods described herein. An encoder or decoder apparatus may include a processor configured to perform the methods described herein. The apparatus may include a computer-readable medium (e.g. a non-transitory medium) storing instructions for performing the methods described herein. In some embodiments, a computer-readable medium (e.g. a non-transitory medium) stores a video encoded using any of the methods described herein.

One or more of the present embodiments also provide a computer readable storage medium having stored thereon instructions for performing bi-directional optical flow, encoding or decoding video data according to any of the methods described above. The present embodiments also provide a computer readable storage medium having stored thereon a bitstream generated according to the methods described above. The present embodiments also provide a method and apparatus for transmitting the bitstream generated according to the methods described above. The present embodiments also provide a computer program product including instructions for performing any of the methods described.

### BRIEF DESCRIPTION OF THE DRAWINGS

FIG. 1A is a system diagram illustrating an example communications system according to some embodiments.

FIG. 1B is a system diagram illustrating an example wireless transmit/receive unit (WTRU) that may be used within the communications system illustrated in FIG. 1A according to some embodiments.

FIG. 1C is a system diagram illustrating an example set of interfaces for a system according to some embodiments.

FIG. 2A is a functional block diagram of block-based video encoder, such as a video compression encoder, according to some embodiments.

FIG. 2B is a functional block diagram of a block-based video decoder, such as a video decompression decoder, according to some embodiments.

FIG. 3A is a schematic illustration showing an example FoldingNet encoder-decoder architecture.

FIG. 3B is a schematic illustration showing an example encoder-decoder architecture according to some embodiments.

FIG. 4A is a functional block diagram illustrating an example fixed-length codeword autoencoder with soft disentanglement according to some embodiments.

FIG. 4B is a schematic illustration showing an example fixed-length codeword autoencoder with soft disentanglement according to some embodiments.

FIG. 5A is a functional block diagram illustrating an example feature map autoencoder process according to some embodiments.

FIG. 5B is a schematic illustration showing an example feature map autoencoder process according to some embodiments.

FIG. 6A is a functional block diagram illustrating an example heterogeneous mesh encoder process according to some embodiments.

FIG. 6B is a schematic illustration showing an example heterogeneous mesh encoder process according to some embodiments.

FIG. 7A is a functional block diagram illustrating an example heterogeneous mesh decoder process according to some embodiments.

FIG. 7B is a schematic illustration showing an example heterogeneous mesh decoder process according to some embodiments.

FIG. 8A is a functional block diagram illustrating an example face convolution down-sampling process according to some embodiments.

FIG. 8B is a schematic illustration showing an example face convolution down-sampling process according to some embodiments.

FIG. 9A is a functional block diagram illustrating an example up-sampling face convolution process according to some embodiments.

FIG. 9B is a schematic illustration showing an example up-sampling face convolution process according to some embodiments.

FIG. 10 is a schematic illustration showing an example aggregation of neighboring faces around a node according to some embodiments.

FIG. 11A is a functional block diagram illustrating an example process for converting face features into differential position updates according to some embodiments.

FIG. 11B is a schematic illustration showing an example process for converting face features into differential position updates according to some embodiments.

FIG. 12A is a functional block diagram illustrating an example process for deforming a base mesh into a canonical sphere shape according to some embodiments.

FIG. 12B is a schematic illustration showing an example index-matching process according to some embodiments.

FIG. 13 is a functional block diagram illustrating an example fixed-length codeword autoencoder with hard disentanglement according to some embodiments.

FIG. 14 is a functional block diagram illustrating an example residual face convolution process according to some embodiments.

FIG. 15 is a functional block diagram illustrating an example inception-residual face convolution according to some embodiments.

FIG. 16 is a functional block diagram illustrating an example partition-based encoding process according to some embodiments.

FIG. 17 is a functional block diagram illustrating an example partition-based decoding process according to some embodiments.

FIG. 18 is a functional block diagram illustrating an example mesh classification architecture based on a fixed-length codeword autoencoder according to some embodiments.

FIG. 19 is a functional block diagram illustrating an example fixed-length codeword autoencoder with soft disentanglement and SphereNet according to some embodiments.

FIG. 20 is a flowchart illustrating an example encoding method according to some embodiments.

FIG. 21 is a flowchart illustrating an example decoding method according to some embodiments.

FIG. 22 is a flowchart illustrating an example encoding process according to some embodiments.

FIG. 23 is a flowchart illustrating an example decoding process according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

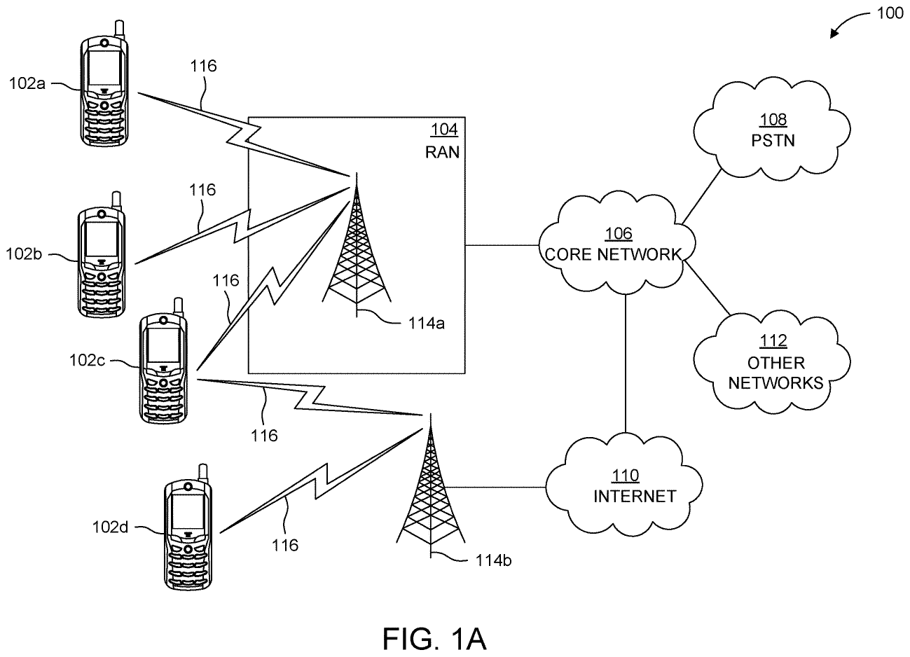

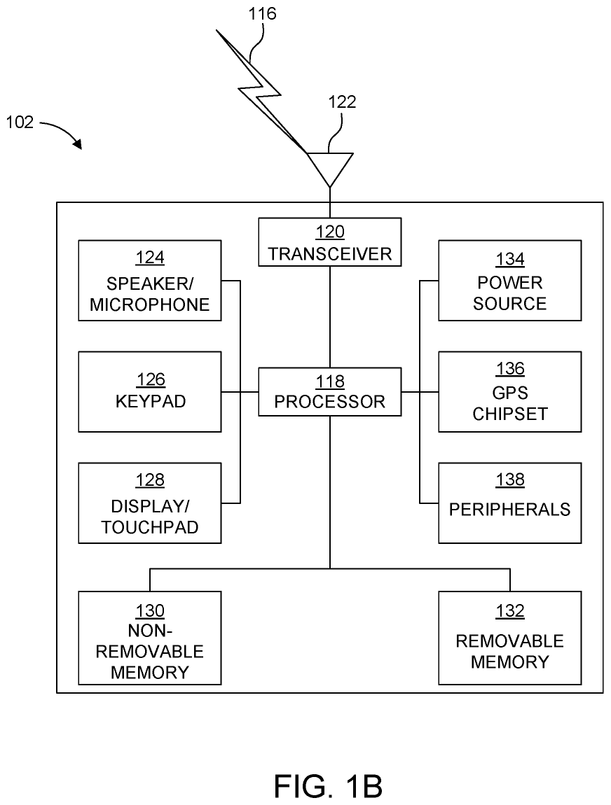

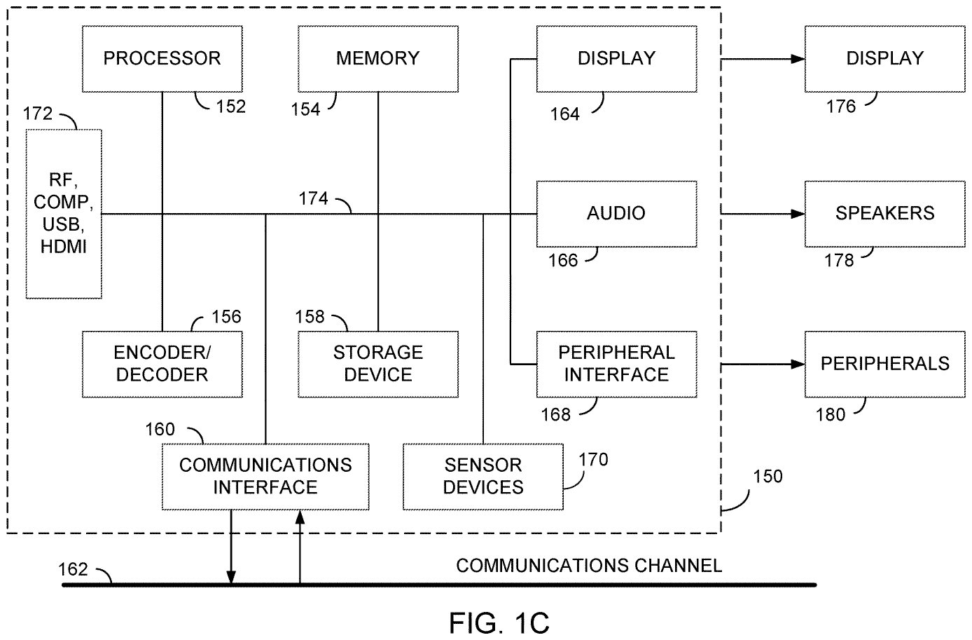

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104/113 may be in communication with the CN 106, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106 may be in direct or indirect communication with other RANs that employ the same RAT as the RAN 104/113 or a different RAT. For example, in addition to being connected to the RAN 104/113, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception)).

Although the WTRU is described in FIGS. 1A-1B as a wireless terminal, it is contemplated that in certain representative embodiments that such a terminal may use (e.g., temporarily or permanently) wired communication interfaces with the communication network.

In representative embodiments, the other network 112 may be a WLAN.

In view of FIGS. 1A-1B, and the corresponding description, one or more, or all, of the functions described herein may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

FIG. 1C is a system diagram illustrating an example set of interfaces for a system according to some embodiments. An extended reality display device, together with its control electronics, may be implemented for some embodiments. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 150 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive.

The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV.Link, Consumer Electronics Control (CEC), or other communications protocols that enable device-to-device control with or without user intervention. The output devices can be communicatively coupled to system 150 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

The embodiments described here include a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

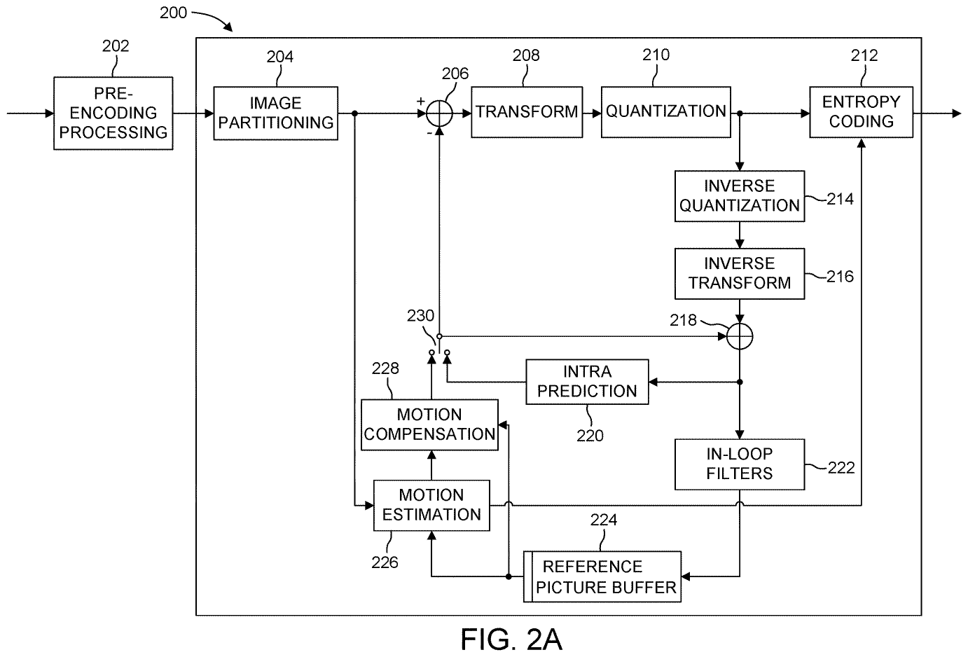

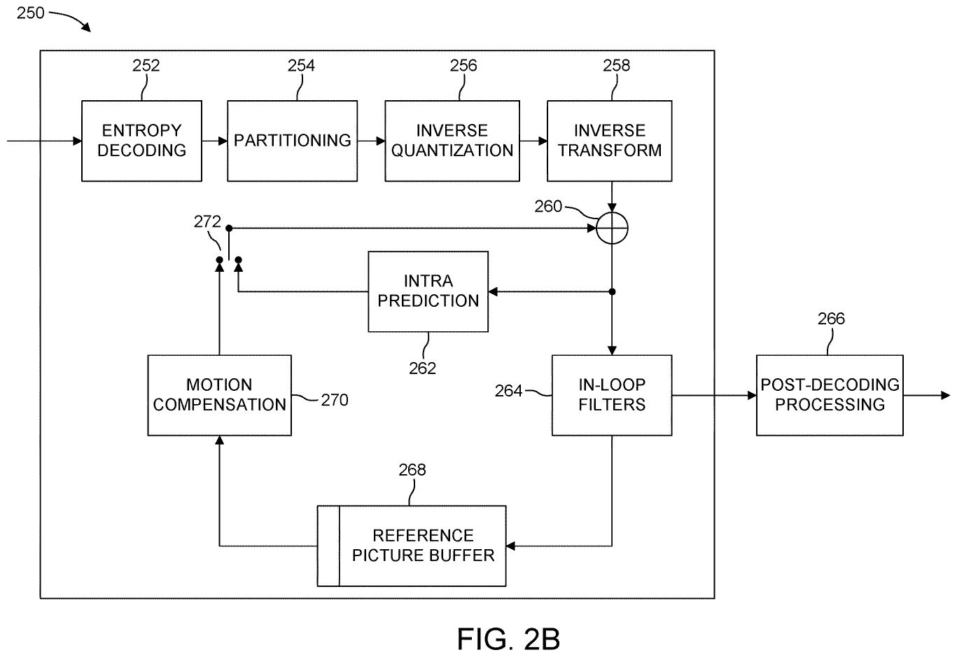

The aspects described and contemplated in this application can be implemented in many different forms. FIGS. 1C, 2A, and 2B provide some embodiments, but other embodiments are contemplated and the discussion of FIGS. 1C, 2A, and 2B does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present application, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” or “reconstructed” is used at the decoder side.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various methods and other aspects described in this application may be used to modify blocks, for example, the intra prediction 220, 262, entropy coding 212, and/or entropy decoding 252, of a video encoder 200 and decoder 250 as shown in FIGS. 2A and 2B. Moreover, the present aspects are not limited to VVC or HEVC, and can be applied, for example, to other standards and recommendations, whether pre-existing or future-developed, and extensions of any such standards and recommendations (including VVC and HEVC). Unless indicated otherwise, or technically precluded, the aspects described in this application can be used individually or in combination.

Various numeric values are used in the present application. The specific values are for example purposes and the aspects described are not limited to these specific values.

FIG. 2A is a functional block diagram of block-based video encoder, such as a video compression encoder, according to some embodiments. FIG. 2A illustrates an encoder 200. Variations of this encoder 200 are contemplated, but the encoder 200 is described below for purposes of clarity without describing all expected variations. Before being encoded, the video sequence may go through pre-encoding processing 202, for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing and attached to the bitstream.

In the encoder 200, a picture is encoded by the encoder elements as described below. The picture to be encoded is partitioned 204 and processed in units of, for example, CUs. Each unit is encoded using, for example, either an intra or inter mode. When a unit is encoded in an intra mode, the encoder performs intra prediction 220. In an inter mode, motion estimation 226 and compensation 228 are performed. The encoder decides 230 which one of the intra mode or inter mode to use for encoding the unit, and indicates the intra/inter decision by, for example, a prediction mode flag. Prediction residuals are calculated, for example, by subtracting 206 the predicted block from the original image block.

The prediction residuals are then transformed 208 and quantized 210. The quantized transform coefficients, as well as motion vectors and other syntax elements, are entropy coded 212 to output a bitstream. The encoder can skip the transform and apply quantization directly to the non-transformed residual signal. The encoder may bypass both transform and quantization, in which the residual is coded directly without the application of the transform or quantization processes.

The encoder decodes an encoded block to provide a reference for further predictions. The quantized transform coefficients are de-quantized 214 and inverse transformed 216 to decode prediction residuals. Combining 218 the decoded prediction residuals and the predicted block, an image block is reconstructed. In-loop filters 222 are applied to the reconstructed picture to perform, for example, deblocking/SAO (Sample Adaptive Offset) filtering to reduce encoding artifacts. The filtered image is stored at a reference picture buffer 224.

FIG. 2B is a functional block diagram of a block-based video decoder, such as a video decompression decoder, according to some embodiments. FIG. 2B illustrates a block diagram of a video decoder 250. In the decoder 250, a bitstream is decoded by the decoder elements as described below. Video decoder 250 generally performs a decoding pass reciprocal to the encoding pass as described in FIG. 2A. The encoder 200 also generally performs video decoding as part of encoding video data.

In particular, the input of the decoder includes a video bitstream, which may be generated by video encoder 200. The bitstream is first entropy decoded 252 to obtain transform coefficients, motion vectors, and other coded information. The picture partition information indicates how the picture is partitioned. The decoder may therefore divide 254 the picture according to the decoded picture partitioning information. The transform coefficients are de-quantized 256 and inverse transformed 258 to decode the prediction residuals. Combining 260 the decoded prediction residuals and the predicted block, an image block is reconstructed. The predicted block may be obtained 272 from intra prediction 262 or motion-compensated prediction (inter prediction) 270. In-loop filters 264 are applied to the reconstructed image. The filtered image is stored at a reference picture buffer 268.

The decoded picture may further go through post-decoding processing 266, for example, an inverse color transform (e.g., conversion from YcbCr 4:2:0 to RGB 4:4:4) or an inverse remapping performing the inverse of the remapping process performed in the pre-encoding processing 202. The post-decoding processing can use metadata derived in the pre-encoding processing and signaled in the bitstream.

This application discloses, in accordance with some embodiments, meshes and point cloud processing, which includes analysis, interpolation representation, understanding, and processing of meshes and point cloud signals.

Point cloud data may consume a large portion of network traffic, e.g., among connected cars over a 5G network and in immersive (e.g., AR/VR/MR) communications. Efficient representation formats may be used for point clouds and communication. In particular, raw point cloud data may be organized and processed for modeling and sensing, such as the world, an environment, or a scene. Compression of raw point clouds may be used with storage and transmission of the data.

Furthermore, point clouds may represent sequential scans of the same scene, which may contain multiple moving objects. Dynamic point clouds capture moving objects, while static point clouds capture a static scene and/or static objects. Dynamic point clouds may be typically organized into frames, with different frames being captured at different times. The processing and compression of dynamic point clouds may be performed in real-time or with a low amount of delay.

The automotive industry and autonomous vehicles are some of the domains in which point clouds may be used. Autonomous cars “probe” and sense their environment to make good driving decisions based on the reality of their immediate surroundings. Sensors such as LiDARs produce (dynamic) point clouds that are used by a perception engine. These point clouds typically are not intended to be viewed by human eyes, and these point clouds may or may not be colored and are typically sparse and dynamic with a high frequency of capture. Such point clouds may have other attributes like the reflectance ratio provided by the LiDAR because this attribute is indicative of the material of the sensed object and may help in making a decision.

Virtual Reality (VR) and immersive worlds have become a hot topic and are foreseen by many as the future of 2D flat video. The viewer may be immersed in an all-around environment, as opposed to standard TV where the viewer only looks at a virtual world in front of the viewer. There are several gradations in the immersivity depending on the freedom of the viewer in the environment. Point cloud formats may be used to distribute VR worlds and environment data. Such point clouds may be static or dynamic and are typically average size, such as less than several millions of points at a time.

Point clouds also may be used for various other purposes, such as scanning of cultural heritage objects and/or buildings in which objects such as statues or buildings are scanned in 3D. The spatial configuration data of the object may be shared without sending or visiting the actual object or building. Also, this data may be used to preserve knowledge of the object in case the object or building is destroyed, such as a temple by an earthquake. Such point clouds, typically, are static, colored, and huge in size.

Another use case is in topography and cartography using 3D representations, in which maps are not limited to a plane and may include the relief. For example, some mapping websites and apps may use meshes instead of point clouds for their 3D maps. Nevertheless, point clouds may be a suitable data format for 3D maps, and such point clouds, typically, are also static, colored, and huge in size.

World modeling and sensing via point clouds may allow machines to record and use spatial configuration data about the 3D world around them, which may be used in the applications discussed above.

3D point cloud data include discrete samples of surfaces of objects or scenes. To fully represent the real world with point samples, a huge number of points may be used. For instance, a typical VR immersive scene includes millions of points, while point clouds typically may include hundreds of millions of points. Therefore, the processing of such large-scale point clouds is computationally expensive, especially for consumer devices, e.g., smartphones, tablets, and automotive navigation systems, which may have limited computational power.

Additionally, discrete samples that include the 3D point cloud data may still contain incomplete information about the underlying surfaces of objects and scenes. Hence, recent efforts are being made to also explore mesh representation for 3D scene/surface representation. Meshes may be considered as a 3D point cloud along with the connectivity information between the points. Thus, a mesh representation bridges the gap between point clouds and the underlying, continuous surfaces through local 2D polygonal patches (called faces) that approximate the underlying surface.

The first step for any kind of processing or inference on the mesh data is to have efficient storage methodologies. To store and process the input point cloud with affordable computational cost, the input point cloud may be down-sampled, in which the down-sampled point cloud summarizes the geometry of the input point cloud while having much fewer (but bigger) faces. The down-sampled point cloud is inputted into a subsequent machine task for further processing. However, further reduction in storage space can be achieved by converting the raw mesh data (original or downsampled) into a fixed length codeword or a feature map living on a very low-resolution mesh. This codeword or the feature map may be converted to a bitstream through entropy coding techniques. Moreover, the codeword or feature map may be used to represent, respectively, global or local surface information of the underlying scene/object and may be paired with subsequent downstream (machine vision) blocks.

The raw data from sensing modalities may produce mesh representations that include hundreds of thousands of faces to be stored efficiently. While compared to point clouds, meshes offer more information regarding the underlying 3D shape that a mesh represents. Meshes provide this additional information through connectivity information. Such connectivity information presents challenges in designing efficient learning-based architectures for mesh processing and compression. This application describes, in accordance with some embodiments, a mesh autoencoder framework used to generate and “learn” representations of heterogenous 3D triangle meshes that parallel convolution-based autoencoders in 2D vision.

Various attempts to design autoencoders on meshes have been made in recent years, such as the autoencoder in article Litany, Or, et al., Deformable Shape Completion with Graph Convolutional Autoencoders, PROCEEDINGS OF THE IEEE CONFERENCE ON COMPUTER VISION AND PATTERN RECOGNITION (2018) (“Litany”) and the Convolutional Mesh Autoencoder (CoMA) in article Ranjan, Anurag, et al., Generating 3D Faces Using Convolutional Mesh Autoencoders, EUROPEAN CONFERENCE ON COMPUTER VISION (ECCV) 704-720 (2018) (“Ranjan”). Litany is understood to treat the mesh purely as a graph and applies a variational graph autoencoder using the mesh geometry as input features. See Kipf, Thomas and Max Welling, Variational Graph Auto-Encoders, arXiv preprint arXiv: 1611.07308 (2016). This method does not have hierarchical pooling and does not apply any mesh-specific operations. Ranjan defines fixed up- and down-sampling operations in a hierarchical fashion, based on quadric error simplification, combined with spectral convolution layers, which is understood to require operating on meshes of the same size and connectivity. This is because the pooling and unpooling operations are predefined and dependent on the connectivity represented as an adjacency matrix.

The articles Bouritsas, Giorgos, et al., Neural 3D Morphable Models: Spiral Convolutional Networks for 3D Shape Representation Learning and Generation, PROCEEDINGS OF THE IEEE/CVF INTERNATIONAL CONFERENCE ON COMPUTER VISION 7213-7222 (2019); Yuan, Yu-Jie, et al., Mesh Variational Autoencoders with Edge Contraction Pooling, PROCEEDINGS OF THE IEEE/CVF CONFERENCE ON COMPUTER VISION AND PATTERN RECOGNITION WORKSHOPS 274-275 (2020); and Zhou, Yi, et al., Fully Convolutional Mesh Autoencoder Using Efficient Spatially Varying Kernels, 33 ADVANCES IN NEURAL INFORMATION PROCESSING SYSTEMS 9251-9262 (2020) improve the convolution layers but are still limited to the fixed size and connectivity constraint.

The article Hanocka, Rana, et al., MeshCNN: A Network with an Edge, 38:4 ACM TRANSACTIONS ON GRAPHICS (TOG) 1-12 (2019) defines learnable up- and down-sampling modules that adapt to different meshes of variable size. These layers are understood to not have been demonstrated to construct a good autoencoder, but rather are for mesh classification and segmentation.

The article Hu, Shi-Min, et al., Subdivision-Based Mesh Convolution Networks, 41:3 ACM TRANSACTIONS ON GRAPHICS (TOG) 1-16 (2022) (“Hu”) investigates subdivision-based mesh processing where the original mesh is converted into a new mesh, called a remeshed mesh, that well approximates the original mesh but exhibits subdivision connectivity (a semi-regular mesh). Broadly speaking, as an example, a semi-regular mesh is imbued with a hierarchical face structure where every face has three neighboring faces (corresponding to its three edges), and a face and its three neighbors can be combined to form a single face. This property makes the semi-regular mesh amenable to fixed up- and down-sampling operations, which is a “cornerstone” of convolution-based architectures. Furthermore, Hu defines learning-based modules on subdivision meshes, which is a general framework that defines face-based convolution layers (treating faces almost like pixels in images). The article Liu, Hsueh-Ti Derek, et al., Neural Subdivision, ARXIV PREPRINT ARXIV: 2005.01819 (2020) implements coarse-to-fine mesh super-resolution capabilities.

For autoencoders, Hahner, Sara and Jochen Garcke, Mesh Convolutional Autoencoder for Semi-Regular Meshes of Different Sizes, PROCEEDINGS OF THE IEEE/CVF WINTER CONFERENCE ON APPLICATIONS OF COMPUTER VISION 885-894 (2022) (“Garcke”) attempts to implement an autoencoder using subdivision meshes and autoencoding capabilities on meshes of different sizes. However, their method described in Garcke is understood to be unable to generate fixed-length latent representations from different sized meshes and to be able to generate only latent feature maps on the base mesh that can be compared only across meshes with the same base mesh connectivity and face ordering. This detail precludes meaningful latent space comparisons across heterogeneous meshes, which may differ in size, connectivity, or ordering. Having a fixed-length latent representation may be preferable in accordance with some embodiments because a fix-length latent representation enables subsequent analysis/understanding about the input mesh geometry.

This application discloses, in accordance with some embodiments, heterogeneous semi-regular meshes and, e.g., how an efficient fixed-length codeword or a feature map generating learning based autoencoder may be used for these heterogeneous meshes.

In image autoencoder systems, the encoder and decoder typically alternate convolution and up/down sampling operations. Due to the fixed grid support of the images, these down- and up-sampling layers may be set with a fixed ratio (e.g., 2× pooling). Moreover, since images may be resized to the same size via interpolation techniques, hard-coded layer sizes may be used that map images to a fixed-size latent representation and back to the original image size. In contrast, triangle mesh data, which includes geometry (a list of points) and connectivity (a list of triangles with indexing corresponding to the points), is variable in size and has highly irregular support. Such a triangle mesh data construct may prevent using a convolution neighborhood structure, using an up- and down-sampling structure, and extracting of fixed-length latent representations from variable size meshes. While other mesh autoencoders may have attempted to resolve some of these issues, it is understood that no other autoencoder method can process heterogeneous meshes and extract meaningful fixed-length latent representations that generalize across meshes of different sizes and connectivity in a fashion similar to image autoencoders.

Comparisons may be made with autoencoders for point cloud data, since point clouds typically have irregular structures and variable sizes. While meshes have included connectivity information which carries more topological information about the underlying surface compared to point clouds, the connectivity information may bring additional challenges. The articles Yang, Yaoqing, et al., Foldingnet: Point Cloud Auto-Encoder via Deep Grid Deformation, PROCEEDINGS OF THE IEEE CONFERENCE ON COMPUTER VISION AND PATTERN RECOGNITION (2018) and Pang, Jiahao, Duanshun Li, and Dong Tian, Tearingnet: Point Cloud Autoencoder to Learn Topology-Friendly Representations, PROCEEDINGS OF THE IEEE/CVF CONFERENCE ON COMPUTER VISION AND PATTERN RECOGNITION (2021) discuss point cloud autoencoders that are able to extract fixed-length latent representation on point clouds of different sizes and reconstruct a point cloud in some canonical ordering which may not be the same as the original ordering of the input point cloud. This detail prevents mesh reconstruction with the original connectivity since connectivity may no longer be aligned with the output point ordering. Also, there is a question of how to integrate the connectivity information into such learning pipelines.

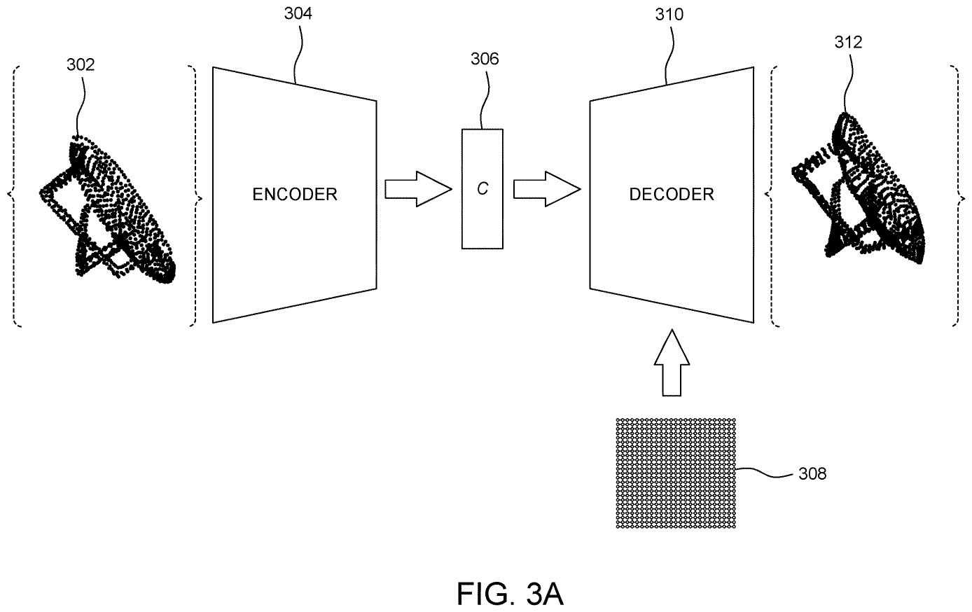

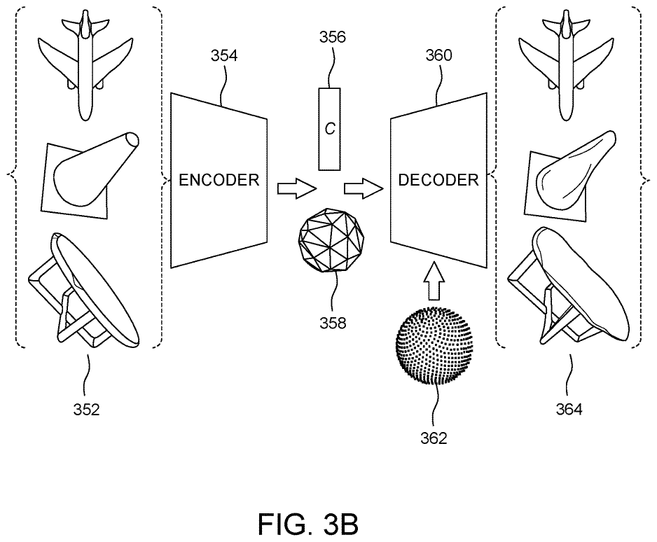

FIG. 3A is a schematic illustration showing an example FoldingNet encoder-decoder architecture. An input mesh 302 is inputted into the encoder 304 and a codeword c 306 is generated at the output. The decoder 310 takes the codeword c 306 and a surface 308 as inputs and reconstructs the mesh 312.

FIG. 3B is a schematic illustration showing an example encoder-decoder architecture according to some embodiments. For some embodiments, a heterogeneous encoder-decoder architecture may be the example HetMeshNet encoder-decoder architecture shown in FIG. 3B. A heterogeneous mesh encoder 354 receives an input mesh 352, which may include a list of features and a list of faces (or triangles for some embodiments), and encodes the input mesh to generate a codeword c 356 and an output mesh 358 of triangles and vertices. The decoder reverses the process. The decoder 360 also takes a uniform sphere 362 with evenly spaced vertices as an input to reconstruct the mesh 364.

This application discusses, in accordance with some embodiments, an end-to-end learning-based mesh autoencoder framework which may operate on meshes of different sizes and handle connectivity while producing fixed-length latent representations, mimicking those in the image domain. In some embodiments, unsupervised transfer classifications may be done across heterogenous meshes, and interpolation may be done in the latent space. Such extracted latent representations, when classified by an SVM, perform similar or better than those extracted by point cloud autoencoders.

Broadly, as an example, a subdivision mesh of level L has a hierarchical face structure in which every face has three neighboring faces (corresponding to its three edges), and a face and its three neighbors may be combined to form a single face, which reverses the loop subdivision operation. This process may be repeated L times, in which each iteration reduces the number of faces by a factor of 4, until the base mesh is reached (which occurs when further reduction may not be possible). Operating on subdivision meshes sets a hierarchical pooling and unpooling scheme that operates globally across the mesh.

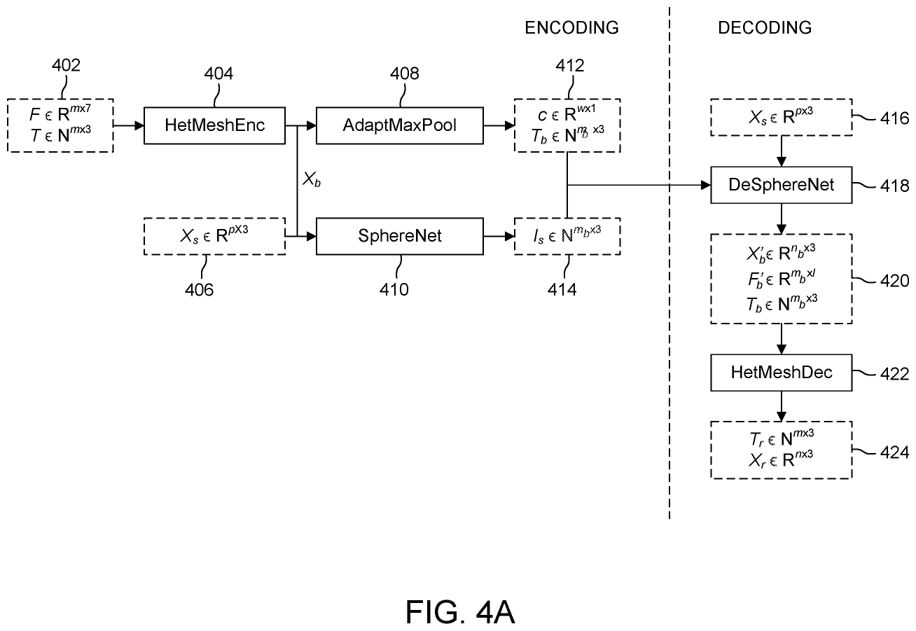

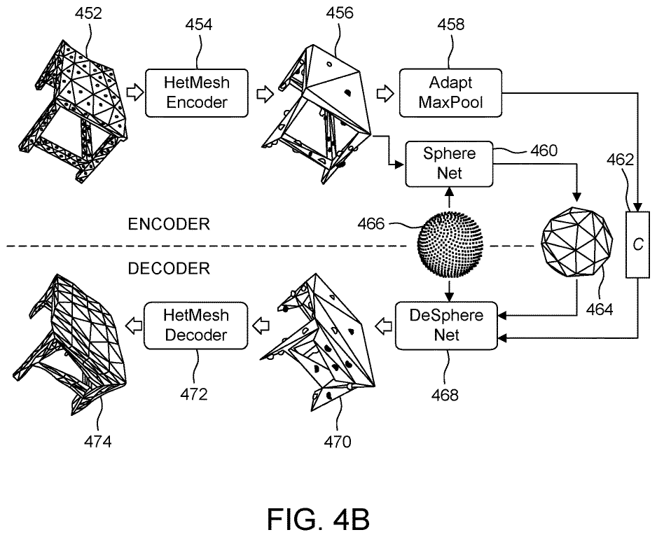

FIG. 4A is a functional block diagram illustrating an example fixed-length codeword autoencoder with soft disentanglement according to some embodiments. For some embodiments, a fixed-length codeword autoencoder with soft disentanglement encoder-decoder architecture may be the example HetMeshNet encoder-decoder architecture shown in FIG. 4A. The mesh autoencoder system (e.g., a HetMeshNet encoder-decoder architecture) extracts fixed-length codewords from heterogeneous meshes of different sizes. To perform a convolution on irregularly structured data, the mesh input may be re-meshed to a subdivision or semi-regular structure for some embodiments. Such re-meshing may alleviate the irregularity of the data and enable a more image-like convolutions. Doing so may also remove the need to explicitly construct or transmit connectivity information at every upsampling step in the decoder. Furthermore, for some embodiments, such a method has the ability either to output a latent feature map on the base mesh, or to learn a fixed-length latent representation. For some embodiments, learning a fixed-length latent representation may be achieved by applying global pooling at the end of the encoder along with a novel module which disassociates latent representation from the base mesh.

In FIG. 4A, several terms are shown as inputs and/or outputs of the various process blocks:
The term F∈ [symbol] ^{m×7} represents a list of features in the input subdivision mesh.
The term F′_{b}∈ [symbol] ^{m}^{_{b}}^{×l} represents a list of features in the intermediate mesh.
The term T∈ [symbol] ^{m×3} represents a list of triangles in the input subdivision mesh.
The term T_{b}∈ [symbol] ^{m}^{_{b}}^{×3} represents a list of triangles in the base mesh.
The term Tᵣ∈ [symbol] ^{m×3} represents a list of triangles in the reconstructed, output mesh.
The term X∈ [symbol] ^{n×3} represents a list of positions in the input subdivision mesh.
The term X_{b} represents a list of positions in the base mesh.
The term X_{b}′∈ [symbol] ⁿ^{_{b}}^{×3} represents a list of positions in an intermediate mesh.
The term Xᵣ∈ [symbol] ^{n×3} represents a list of positions in the reconstructed, output mesh.
The term Xₛ∈ [symbol] ^{p×3} represents a list of positions on a unit sphere.
The term Iₛ∈ [symbol] ^{m}^{_{b}}^{×3} represents a list of matching indices on a unit sphere.
The term c∈ [symbol] ^{w×1} represents a codeword.

For some embodiments of an autoencoder, such as the one shown in FIG. 4A, a single input subdivision mesh may be represented as: (1) a list of positions, X∈ [symbol] ^{n×3}; and (2) a list of triangles, T∈ [symbol] ^{m×3}, which contain indices of the corresponding points. Due to the structure of subdivision meshes, the base mesh is immediately known, with corresponding positions (X_{b}) and triangles (T_{b}). The heterogeneous mesh encoder (e.g., HetMeshEnc 404) consumes the input subdivision mesh 402 through a series of DownFaceConv layers (not shown in FIG. 4A) and outputs an initial feature map over the faces of the base mesh T_{b}. Say, the initial feature map is in w×m_{b} and the face of the base mesh is in m_{b}×3. The DownFaceConv process may include face convolution layers followed by a reverse loop of subdivision pooling. The AdaptMaxPool process 408 is applied across the faces to generate a single latent vector (c∈ [symbol] ^{w×1}) 412 while also deforming the base mesh into a canonical sphere shape 414 using a learnable process (SphereNet 410) and a list of positions on a unit sphere 406. In one embodiment, the AdaptMaxPool is just to max pool the feature map w×m_{b} over the list of m_{b} faces, and to generate a w-dim latent vector. In another embodiment, a series of face-wise fully connected multi-layer perceptron (MLP) layers is first applied before applying the max pooling. The introduced MLPs take each face-wise feature as input and conduct feature aggregations for an enhanced representability.

For decoding, in accordance with some embodiments, the sphere shape and latent vector are first deformed back into the base mesh 420 using another learnable process (e.g., DeSphereNet 418, which may in some embodiments have the same architecture as SphereNet 410). For some embodiments, DeSphereNet 418 may use a list of positions on a unit sphere 416 as an input. DeSphereNet 418 may include a series of face convolutions and a mesh processing layer, Face2Node. With an estimate of the base mesh and the codeword, the heterogeneous mesh decoder (e.g., HetMeshDec 422) may use UpFaceConv layers (a loop of subdivision unpooling, face convolutions and Face2Node layers) to perform the decoding and produce a final reconstructed mesh 424 at the same resolution as the input subdivision mesh 402. FIG. 4A presents a diagram for this overall example pipeline.

For some embodiments, the Face2Node block is used to transform features from the face domain to the node domain. For some embodiments, the Face2Node block may be used in, e.g., a HetMeshEncoder block, a HetMeshDecoder block, a SpereNet block, and/or a DeSphereNet block. For some embodiments, the focus of the autoencoder is to generate a codeword that is passed through an interface between the encoder and the decoder.

For some embodiments, the AdaptMaxPool block is architecturally similar to a PointNet block, by first applying a face-wise multi-layer perception (MLP) process, followed by a max pooling process, followed by another MLP process. The AdaptMaxPool block treats the face feature map outputted by the heterogeneous mesh encoder (e.g., HetMeshEnc) as a “point cloud.”

The full end-to-end architecture is shown in FIG. 4A. The SphereNet process may be pretrained with a Chamfer loss with 3D positions sampled from a unit sphere, and the weights may be fixed when the rest of the model is trained. During the SphereNet process, a loss on every level of subdivision is enforced at the decoder. For some embodiments, the decoder outputs a total of K+1 lists of positions. The first one is the base mesh reconstruction from the output of the DeSphereNet process, and the remaining K lists of positions are generated by the HetMeshDecoder block, which outputs a list of positions for each level of subdivision. Due to the subdivision mesh structure, correspondence between the input mesh and the output list of positions is maintained. Hence, a squared L2 loss between every output list of positions and the input mesh geometry is supervised.

In some embodiments, the face features that propagate throughout the model are ensured to be local to the region on which the mesh the face resides. Additionally, the face features have “knowledge” of their global location. Furthermore, the model is invariant to ordering of the faces or nodes. In this sense, the SphereNet locally deforms regions on the base mesh to a sphere, and the decoder locally deforms the sphere mesh back into the original shape. The global orientation of the shape is kept within the sphere. In other words, while the model is not guaranteed to be equivariant to 3D rotations, the use of local feature processing helps to achieve this capability.

FIG. 4B is a schematic illustration showing an example fixed-length codeword autoencoder with soft disentanglement according to some embodiments. For some embodiments, a fixed-length codeword autoencoder with soft disentanglement encoder-decoder architecture may be the example HetMeshNet encoder-decoder architecture shown in FIG. 4B. The schematic illustration of FIG. 4B shows how an example mesh object (a table) 452 is transformed at each stage of FIG. 4B. In some embodiments, FIG. 4B shows the same example process as FIG. 4A.

For some embodiments, a Heterogeneous Mesh Encoder 454 encodes an input mesh object 452 to output an initial feature map 456 over the faces of a base mesh. An AdaptMaxPool process 458 is applied across the faces to generate a latent vector codeword c 462. A learnable process (e.g., SphereNet 460) deforms the base mesh into an output sphere shape 464 using an input list of positions on a unit sphere 466. The sphere shape 464 is also known as base graph or base connectivity in this application. For some embodiments, another learnable process (e.g., DeSphereNet 468) may deform the sphere shape 464 based on the latent vector codeword c 462 back into a base mesh 470. With an estimate of the base mesh 470 and the codeword, the heterogeneous mesh decoder 472 may perform the decoding and produce a final reconstructed mesh 474 at the same resolution as the input subdivision mesh 452.

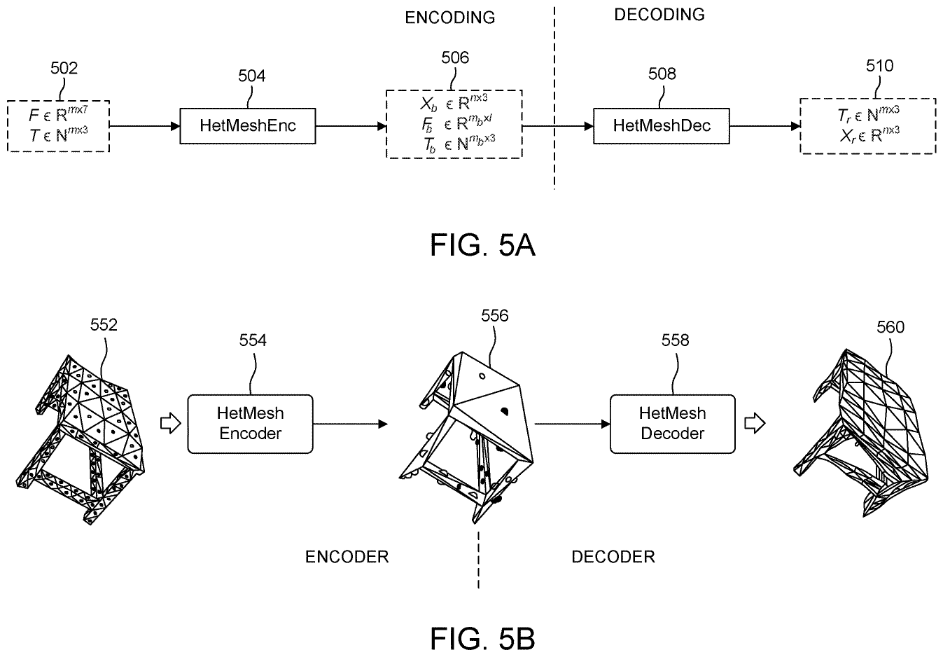

FIG. 5A is a functional block diagram illustrating an example feature map autoencoder process according to some embodiments. For generating a feature map 506 rather than a codeword, the AdaptMaxPool block may be skipped, and thus SphereNet and DeSphereNet are not used because the base mesh itself is transmitted to the decoder. FIG. 5A presents a diagram for this example procedure. For some embodiments, a heterogeneous mesh encoder 504 encodes an input mesh 502 into a base mesh 506, and a heterogeneous mesh decoder 508 decodes the input base mesh 506 into an output mesh 510. Both examples of an autoencoder (FIGS. 4A and 5A) are trained end-to-end with MSE loss at each reconstruction stage with the ground truth re-meshed mesh at that stage.

Face-centric features may be propagated throughout the model. The input features may be sought to be invariant to ordering of nodes and faces, and global position or orientation of the face. Hence, the input face features may be chosen to be the normal vector of the face, the face area, and a vector containing curvature information of the face. For face i, let j₀, j₁, and j₂ denote the face indices of its 3 neighbors. The curvature vector is given by equation 1:

$$curvature vector = {c}_{i} - \frac{1}{3} ( {c}_{{j}_{0}} + {c}_{{j}_{1}} + {c}_{{j}_{2}} ) \qquad Eq . 1$$

where cᵢ, cⱼ_{₀}, cⱼ_{₁}, cⱼ_{₂} are the centroids of the faces, respectively. Thus, a total of 7 input features are used for any process block that consumes a mesh directly but uses some input face features.

For some embodiments, a latent feature map 506 on the base mesh may be used, as shown in FIG. 5A, rather than a single fixed-length latent code. Such a model may be used to compare with other recent mesh autoencoders that perform latent space comparisons between meshes with the same connectivity.

FIG. 5B is a schematic illustration showing an example feature map autoencoder process according to some embodiments. The schematic illustration of FIG. 5B shows how an example mesh object (a table) 552 is transformed at each stage of FIG. 5B. In some embodiments, FIG. 5B shows the same example process as FIG. 5A. For some embodiments, a heterogeneous mesh encoder 554 encodes an input mesh 552 into a base mesh 556, and a heterogeneous mesh decoder 558 decodes the input base mesh 556 into an output mesh 560.

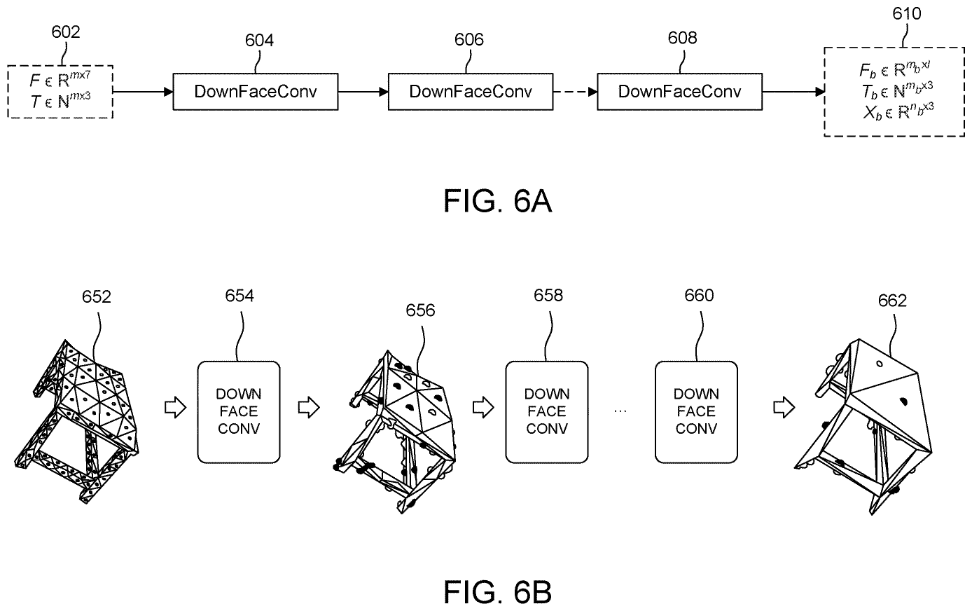

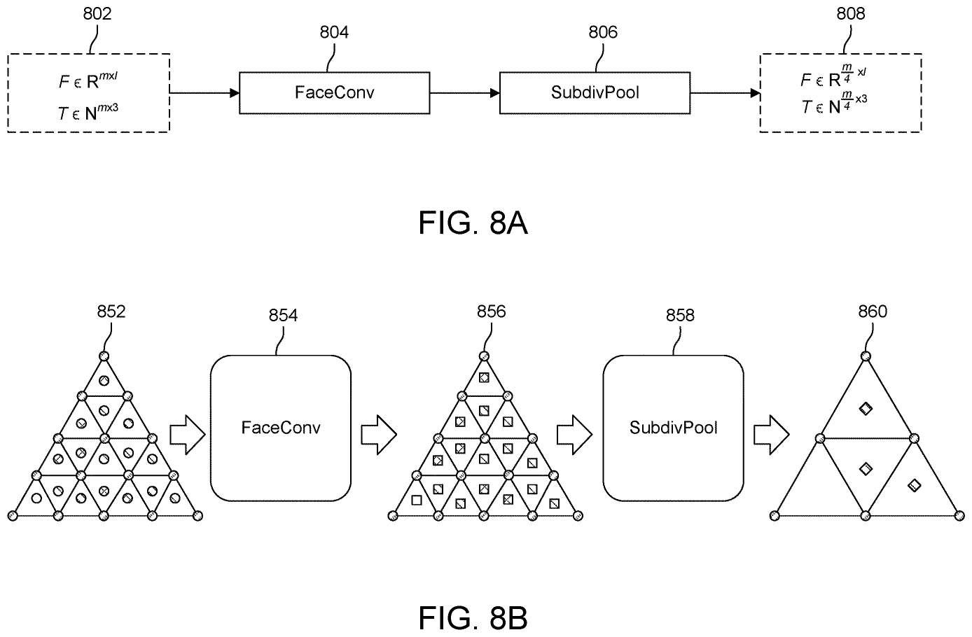

FIG. 6A is a functional block diagram illustrating an example heterogeneous mesh encoder process according to some embodiments. For some embodiments, a heterogeneous mesh encoder process may be the example HetMeshEncoder process shown in FIG. 6A. The encoding process shown in FIG. 6A and named HetMeshEnc includes K repetitions of DownFaceConv layers 604, 606, 608 (shown in FIG. 8A) to encode the input mesh 602 into a base mesh 610. Each DownFaceConv layer is a pair of FaceConv and SubDivPool. The FaceConv layer (see Hu) is a mesh face feature propagation process given a subdivision mesh. The FaceConv layer works similar to a traditional 2D convolution; alearnable kernel defined on the faces of the mesh visits each face of the mesh and aggregates local features from adjacent faces to produce an updated feature for the current face. The article Loop, Charles, Smooth Subdivision Surfaces Based on Triangles (1987) (“Loop”) discusses subdivision-based pooling/downsampling (SubdivPool). For some embodiments, the SubdivPool block (or layer for some embodiments) merges sets of four adjacent mesh faces into one larger face and thereby reduces the overall number of faces. For some embodiments, a face may be a triangle. Moreover, the features for the merged faces (if any) are averaged to obtain the feature of the resulting face.

An end-to-end autoencoder architecture may be bookended by an encoder block, labeled HetMeshEncoder, and a decoder block, labeled HetMeshDecoder. These blocks perform multiscale feature processing. The HetMeshEncoder extracts and pools features onto a feature map supported on the faces of a base mesh. At the decoder, the HetMeshDecoder receives as an input an approximate version of the base mesh and super-resolves the base mesh input back into a mesh of the original size. For some embodiments, the HetMeshEncoder block, shown in FIG. 6A, may be a series of K repetitions of DownFaceConv layers. The DownFaceConv and FaceConv blocks are described in more detail below.

FIG. 6B is a schematic illustration showing an example heterogeneous mesh encoder process according to some embodiments. For some embodiments, a heterogeneous mesh encoder process may be the example HetMeshEncoder process shown in FIG. 6B. The schematic illustration of FIG. 6B shows how an example mesh object (a table) 652 is transformed at each stage of FIG. 6B. In some embodiments, FIG. 6B shows the same example process as FIG. 6A. The encoding process shown in FIG. 6B includes K repetitions of DownFaceConv layers 654, 658, 660 to encode the input mesh 652 into a base mesh 662 via a series of intermediate meshes 656.

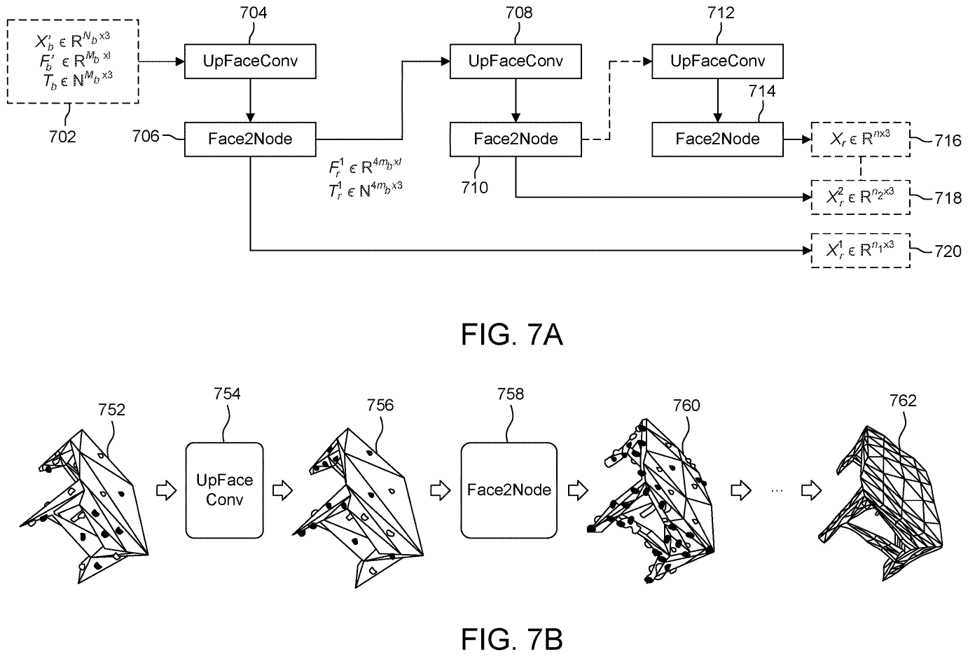

FIG. 7A is a functional block diagram illustrating an example heterogeneous mesh decoder process according to some embodiments. For some embodiments, a heterogeneous mesh decoder process may be the example HetMeshDecoder process shown in FIG. 7A to transform the received base mesh 702. The example decoder shown in FIG. 7A, named HetMeshDecoder, includes K repetitions of a pair of blocks (which may be appended at the location of the dashed arrow of FIG. 7A): an UpFaceConv layer 704, 708, 712 and a Face2Node layer 706, 710, 714. Each UpFaceConv layer, shown in FIG. 7A, is a pair of FaceConv and SubDivUnpool blocks. The FaceConv block may be the same as in the encoder, while using a subdivision-based unpooling/upsampling block, SubDivUnpool. See Loop. Each Face2Node layer 706, 710, 714 may output an intermediate list of reconstructed positions 716, 718, 720.

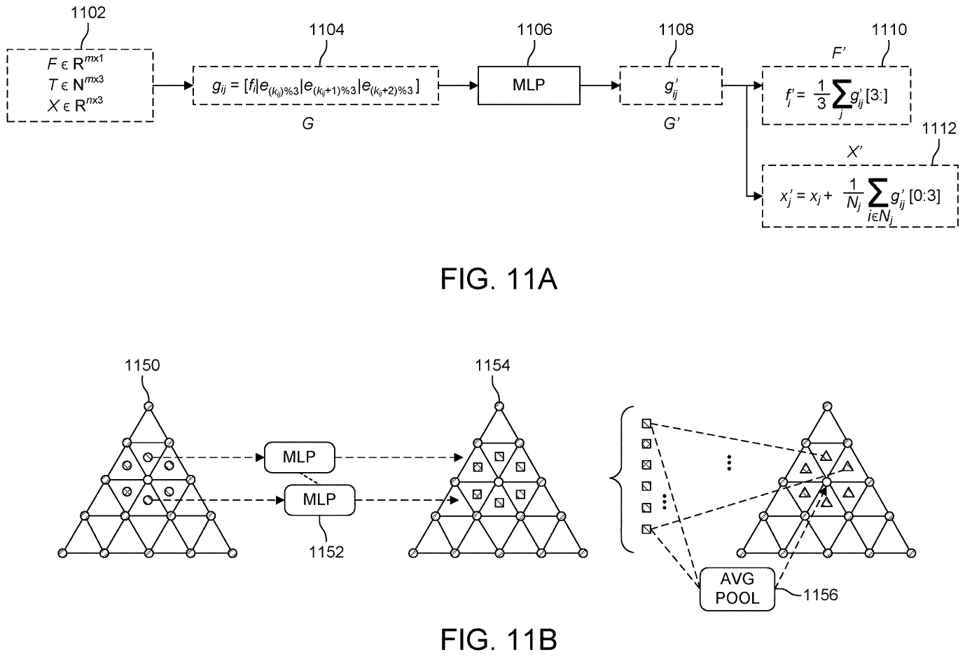

The HetMeshDecoder block, shown in FIG. 7A, nearly mirrors the HetMeshEncoder, except the HetMeshDecoder block inserts a Face2Node block in between each UpFaceConv block. This insertion is not necessarily to reconstruct a feature map supported on the original mesh but rather to reconstruct the mesh shape itself, which is defined by geometry positions. For comparison, in images, the goal is to reconstruct a feature map over the support of the image which corresponds to pixel values. The Face2Node block, which is discussed in further detail with regard to FIG. 11A, receives face features as inputs and outputs new face features as well as a differential position update for each node in the mesh. The SubdivUnpool block (or layer for some embodiments) inserts a new node at the midpoint of each edge of the previous layer's mesh, which subdivides each triangle into four. The face features of these new faces may be copied from their parent face. A FaceConv layer updates the face features, which may be passed to a Face2Node block to update (all) node positions.

The Face2Node block outputs a set of positions in a reconstructed mesh, Xᵣ^{α} ∈ [symbol] ⁿ^{ₐ}^{×3} for a particular iteration a. For example, the output from the first Face2Node block is Xᵣ^{α}∈ [symbol] ⁿ^{₁}^{×3}. For some embodiments, the heterogeneous mesh decoder (e.g., HetMeshDecoder) may be a series of UpFaceConv and Face2Node blocks. For example, the series may be 5 sets of such blocks.

FIG. 7B is a schematic illustration showing an example heterogeneous mesh decoder process according to some embodiments. For some embodiments, a heterogeneous mesh decoder process may be the example HetMeshDecoder process shown in FIG. 7B. The schematic illustration of FIG. 7B shows how an example mesh object (a table) 752 is transformed at each stage 754, 758 of FIG. 7B to generate a series of intermediate reconstructed mesh objects 756, 760 and a final reconstructed mesh object 762 for some embodiments. In some embodiments, FIG. 7B shows the same example process as FIG. 7A.

FIG. 8A is a functional block diagram illustrating an example face convolution down-sampling process according to some embodiments. For some embodiments, a face convolution down-sampling process may be the example DownFaceConv process shown in FIG. 8A. A DownFaceConv layer is a FaceConv layer 804 followed by a SubdivPool layer 806. The FaceConv block determines face neighborhoods and performs a convolution aggregation operation over features on the faces. For some embodiments, the DownFaceConv process may transform an input mesh 802 into an output mesh 808. For some embodiments, the DownFaceConv process shown in FIG. 8A may be performed for the DownFaceConv blocks shown in FIG. 6A.

FIG. 8B is a schematic illustration showing an example face convolution down-sampling process according to some embodiments. For some embodiments, a face convolution down-sampling process may be the example DownFaceConv process shown in FIG. 8B. The schematic illustration of FIG. 8B shows how an example mesh object 852 is transformed at each stage 854, 858 of FIG. 8B to generate an intermediate mesh object 856 and an output mesh object 860 for some embodiments. In some embodiments, FIG. 8B shows the same example process as FIG. 8A.

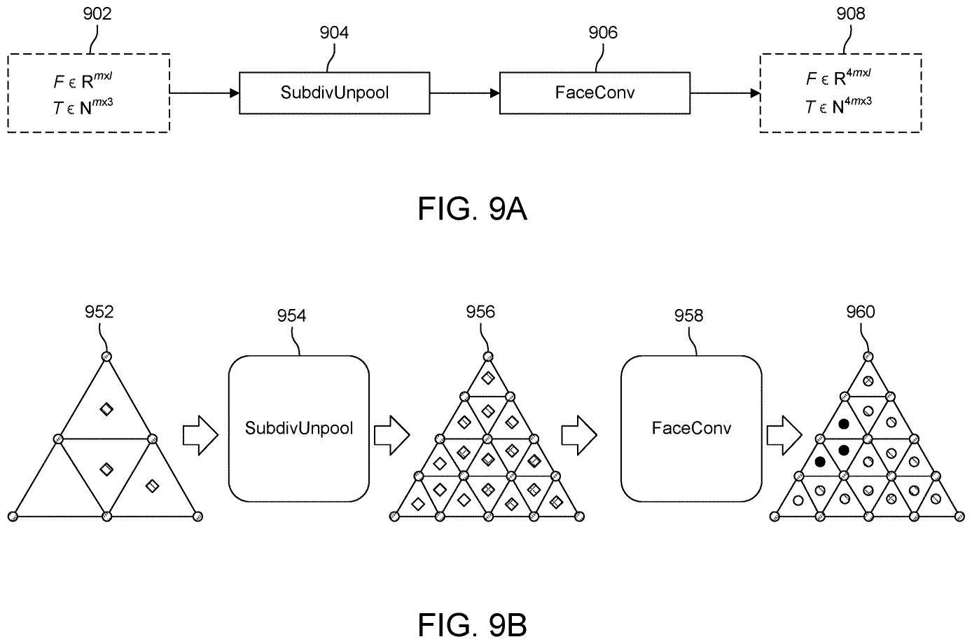

FIG. 9A is a functional block diagram illustrating an example up-sampling face convolution process according to some embodiments. For some embodiments, an up-sampling face convolution process may be the example UpFaceConv process shown in FIG. 9A. An UpFaceConv layer is a SubdivUnpool layer 904 followed by a FaceConv layer 906. As mentioned above, the FaceConv block determines face neighborhoods and performs a convolution aggregation operation over features on the faces. According to some embodiments, SubdivUnpool does the opposite of SubdivPool and converts one mesh face into four smaller faces following the loop subdivision pattern. The features (if any) of the resulting smaller four faces are copies of the original larger face. For some embodiments, the UpFaceConv process may transform an input mesh 902 into an output mesh 908. For some embodiments, the UpFaceConv process shown in FIG. 9A may be performed for the UpFaceConv blocks shown in FIG. 7A.

FIG. 9B is a schematic illustration showing an example up-sampling face convolution process according to some embodiments. For some embodiments, an up-sampling face convolution process may be the example UpFaceConv process shown in FIG. 9B. The schematic illustration of FIG. 9B shows how an example mesh object 952 is transformed at each stage 954, 958 of FIG. 9B to generate an intermediate mesh object 956 and an output mesh object 960 for some embodiments. In some embodiments, FIG. 9B shows the same example process as FIG. 9A.

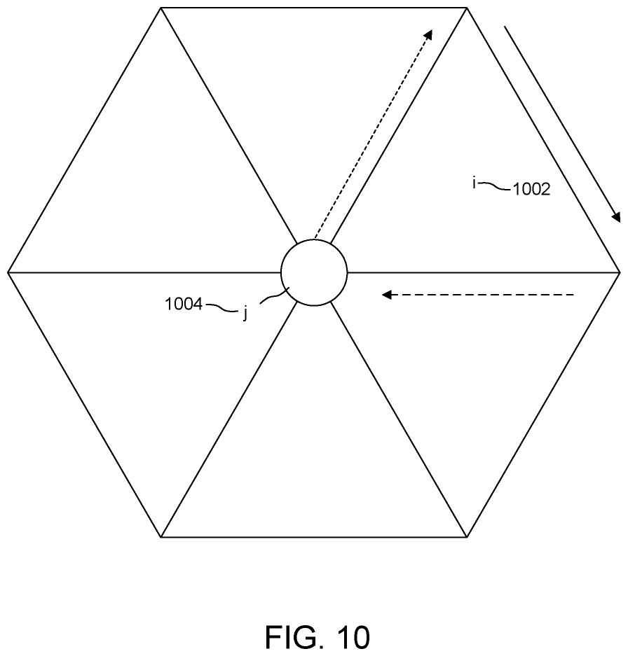

FIG. 10 is a schematic illustration showing an example aggregation of neighboring faces around a node according to some embodiments. Edge vectors are concatenated to the input face feature of face i 1002 with the starting point given by node j's 1004 index in face i 1002. In this example, for face i, the edge vectors are concatenated in the order of the dotted line edge vector first, the solid line edge vector second, and the dashed line edge vector third. The direction of the nodes in each face are predefined so that the normal vectors point outward.

FIG. 11A is a functional block diagram illustrating an example process for converting face features into differential position updates according to some embodiments. For some embodiments, the process for converting face features into differential position updates may be the example Face2Node process shown in FIG. 11A. The example Face2Node block shown in FIG. 11A converts a set of face features directly into associated node position updates for the node and updated set of face features. This layer architecture is described below. For some embodiments, the Face2Node process shown in FIG. 11A may be performed for the Face2Node blocks shown in FIG. 7A.

The loop subdivision based unpooling/upsampling performs upsampling on an input mesh in a deterministic manner and is akin to naïve upsampling in the 2D image domain. Thus, the output node locations in the upsampled mesh are fixed given the input mesh node positions. In accordance with some embodiments, aiming to output the best reconstruction of the input mesh given the codeword, the intermediate, lower-resolution reconstructions may be monitored as well. Such monitoring may enable scalable decoding depending on the desired decoded resolution and the decoder resources, rather than being restricted to (always) outputting a reconstruction matching the resolution of the input mesh.

The Face2Node block converts face features into differential position updates in a permutation-invariant way (with respect to both face and node orderings). Ostensibly, each face feature carries some information about its region on the surface and where the feature is located. All the face features on faces that contain a node v may be aggregated to update that node's position.

The Face2Node layer receives the face list, face features, node locations, and face connectivity as inputs 1102 and outputs the updated node locations corresponding to an intermediate approximation of the input mesh along with the associated updated face features. The face features may be represented as F∈ [symbol] ^{m×l} and the set of node locations may be represented as X∈ [symbol] ^{n×3}. The Face2Node block reconstructs a set of augmented node-specific face features G, which may be considered as the face features from the point of view of specific nodes that are a part of those faces.

For example, [symbol] denote the neighborhood of all the faces that contain node j as a vertex, and let fᵢ denote the feature of the i-th face. Suppose that node j is the k-th node of the i-th mesh face, where k may be 0, 1, or 2. Face2Node concatenates edge vectors to fᵢ. If x₀, x₁, and x₂ are the geometry positions of the three nodes of face i, the predefined edge vectors are given by Eqns. 2 to 4:

$${e}_{0} = {x}_{1} - {x}_{0} \qquad Eq . 2$$

$${e}_{1} = {x}_{2} - {x}_{1} \qquad Eq . 3$$

$${e}_{2} = {x}_{0} - {x}_{2} \qquad Eq . 4$$

The edge vectors are concatenated in a cyclic manner depending on the index of the reference node index in the face kᵢⱼ (hence the modulus). The order of concatenation is used to maintain permutation invariance with respect to individual faces. The node indices of the faces are ordered in a direction so that the normal vectors point outward. The starting point in the face is set to node j. For example, if node j happens to correspond to position x₁, then the edge vectors are concatenated in the order e₁, e₂, e₀ and the combined features are given by equation 5:

$${g}_{i 1} = [ {f}_{i} \vert {e}_{1} \vert {e}_{2} \vert {e}_{0} ] \qquad Eq . 5$$

The other two possibilities for this example are given by equations 6 and 7:

$${g}_{i 2} = [ {f}_{i} \vert {e}_{2} \vert {e}_{0} \vert {e}_{1} ] \qquad Eq . 6$$

$${g}_{i 0} = [ {f}_{i} \vert {e}_{0} \vert {e}_{1} \vert {e}_{2} ] \qquad Eq . 7$$

For notational convenience, the concatenated feature will be denoted as gᵢⱼ for node j in face i. FIG. 11A shows an implementation of this process, which is face-centric.

The face feature fᵢ according to node j is shown in Eq. 8, which is:

$${g}_{ij} = [ {f}_{i} \vert {e}_{( {k}_{ij} ) \%3} \vert {e}_{( {k}_{ij} + 1 ) \%3} \vert {e}_{( {k}_{ij} + 2 ) \%3} ] \qquad Eq . 8$$

where kᵢⱼ represents the index of node j in the i-th mesh face, % 3 represents modulus with respect to 3, and eₗ represents the l-th edge vector.

The set of augmented, node-specific face features G 1104 is updated using a shared MLP block 1106 that operates on each gᵢⱼ in parallel:

$${g}_{ij}^{′} = MLP ( {f}_{i} \vert {e}_{( {k}_{ij} ) \%3} \vert {e}_{( {k}_{ij} + 1 ) \%3} \vert {e}_{( {k}_{ij} + 2 ) \%3} ) \qquad Eq . 9$$

Face2Node updates the concatenated face features for all three node orderings initiated at node j and outputs the updated node-specific feature set G′ 1108.

The differential position update for node j is the average of the first 3 components of

$${g}_{ij}^{′}$$

over the adjacent faces of node j as shown in equation 10:

$${Δ}_{j} = \frac{1}{\vert {𝒩}_{j} \vert} {\sum }_{i ∈ {N}_{j}} {g}_{ij}^{′} [ 0 : 3 ] \qquad Eq . 10$$

The updated node locations 1112 are obtained from neighborhood averaging as shown in Eqs. 11 and 12:

$${x}_{j}^{′} = {x}_{j} + {Δ}_{j} \qquad Eq . 11$$

$${x}_{j}^{′} = {x}_{j} + \frac{1}{{N}_{j}} {\sum }_{i ∈ {N}_{j}} {g}_{ij}^{′} [ 0 : 3 ] \qquad Eq . 12$$

where the neighborhood Nⱼ is defined by all the faces that contain node j as a vertex. The updated face feature

$${f}_{i}^{′}$$

is the average of the updated node-specific features 1110 as shown in Eq. 13:

$${f}_{i}^{′} = \frac{1}{3} {\sum }_{j} {g}_{ij}^{′} [ 3 : ] \qquad Eq . 13$$

The face features are updated by averaging over all three versions of

$${g}_{ij}^{′}$$

[3:] for the i-th face. The notation “[3:]” refers to matrix indices 3, 4, 5, . . . to the end of a matrix. F′ refers to the set of updated node-specific features

$${f}_{i}^{′}$$

for the set of values of i, and X′ refers to the set of updated node locations

$${x}_{j}^{′}$$

for the se of values of j.

FIG. 11B is a schematic illustration showing an example process for converting face features into differential position updates according to some embodiments. For some embodiments, a process for converting face features into differential position updates may be the example Face2Net process shown in FIG. 11B. The schematic illustration of FIG. 11B shows how an example mesh 1150 (a set of triangles) is transformed at each stage of FIG. 11B. In some embodiments, FIG. 11B shows the same example process as FIG. 11A. For some embodiments, an example mesh 1150 is processed by an MLP process 1152 into a node-specific feature set 1154. As shown in FIG. 11B, an example average pool 1156 may be generated for an example node.

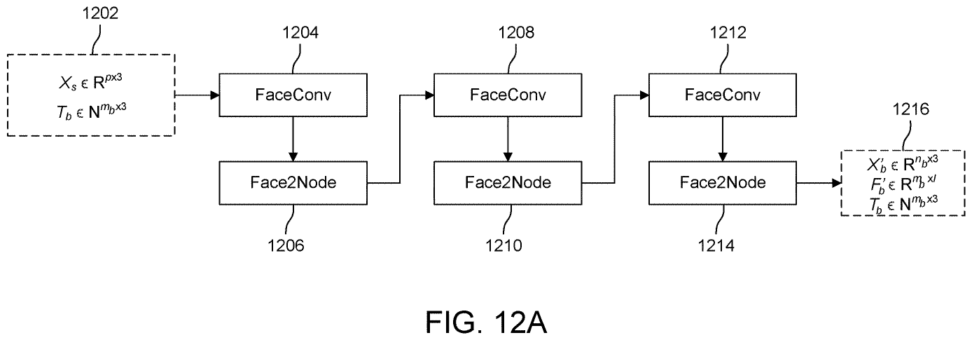

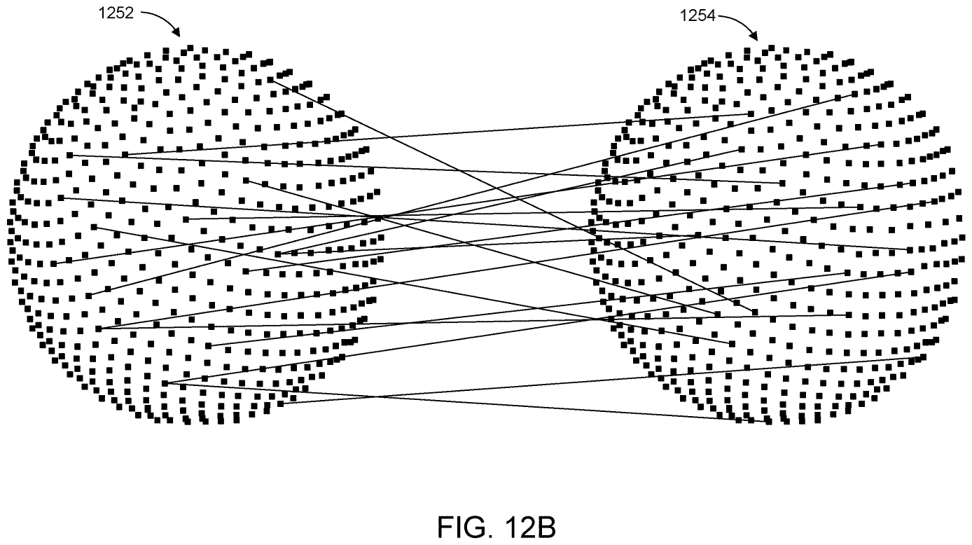

FIG. 12A is a functional block diagram illustrating an example process for deforming a base mesh into a canonical sphere shape according to some embodiments. For some embodiments, a process for deforming a base mesh 1202 into a canonical sphere 1216 may be the example SphereNet process shown in FIG. 12A. In some embodiments of a fixed length codeword autoencoder, geometry information (mesh vertex positions) is injected at different scales into the fixed length codeword, especially the base mesh geometry. Without forcing this information into the codeword, the quality of the codeword may be (severely) diminished, and the codeword may contain just a summary of local face-specific information, which degrades the performance of the codeword when paired with a downstream task like classification or segmentation.

To achieve a (soft) disentanglement of this geometry information, an example SphereNet process, which is shown in FIG. 12A, may be used. A SphereNet process seeks to match the base mesh geometry to a predefined sphere geometry that includes a set of points sampled on a unit sphere. For some embodiments, such matching may be done by deforming the base mesh geometry into an approximate sphere geometry and matching the approximate and actual sphere geometries using either an EMD (Earth Mover Distance) or Sinkhorn algorithm. For some embodiments, only the output of this matching is transmitted to the decoder. As such, the codeword learned from the autoencoder (including the encoder and the decoder) is forced to learn a better representation of the geometry information. For some embodiments, the SphereNet architecture may be trained separately or in tandem with an overall autoencoder in an end-to-end fashion supervised by the Chamfer distance. For some embodiments, the SphereNet architecture includes three pairs of FaceConv 1204, 1208, 1212 and Face2Node 1206, 1210, 1214 layers to output sphere-mapped base mesh vertex positions 1216 using face features of a base mesh 1202.

In accordance with some embodiments, on the decoder side, an example process such as a DeSphereNet process may be used. In some embodiments, the DeSphereNet process may have the same architecture (but different parameters) as SphereNet. The DeSphereNet process may be used to reconstruct the base mesh geometry from the matched points on an actual sphere.

In another implementation, instead of using the learning-based module SphereNet, the deforming/wrapping can be performed via a traditional non-learning-based procedure. This procedure can make use of the Laplacian operator obtained from the connectivity of the base mesh, i.e., the base graph (also known as sphere shape or base connectivity in this application). In particular, by repeatedly applying the cotangent Laplacian to mesh vertex positions, the mesh surface area is to be minimized by marching the surface along the mean curvature normal direction. The result of this iterative application of the cotangent Laplacian operator is a smoothed mesh that closely resembles a sphere mesh having the same connectivity as the original base mesh.

For some embodiments, a feature map on the base mash may be extracted at the encoder side, and super resolution capabilities from the feature map may be extracted on the decoder side. Such a system may be used to extract latent feature maps on the base mesh. For subdivision meshes that contain the same connectivity and face ordering but different geometries, a heterogeneous mesh encoder (e.g., HetMeshEncoder) and a heterogenous mesh decoder (e.g., HetMeshDecoder) extract (meaningful) latent representations because the feature maps across different meshes are the same size and are aligned with each other.

In accordance with some embodiments, however, in order to extend this result to meshes of differing connectivity and size, a fixed-length latent code is extracted no matter the size or connectivity, and the latent code is disentangled from the base mesh shape. The latter goal results from the desire to know the base mesh's connectivity at the decoder. This knowledge of the base mesh's connectivity is used in order to perform loop subdivision. If the base mesh geometry is also sent as-is, the geometry also contains relevant information about the mesh shape and restrict the information that the latent code may contain.

At the encoder, a fixed-length latent code is extracted by pooling the feature map across all the faces. For some embodiments, max-pooling may be performed followed by an MLP layer process. In order to disentangle the latent code from the base mesh, a SphereNet process is used. The goal of the SphereNet block is to deform the base mesh into a canonical 3D shape. A sphere is chosen due to some of the equivalence properties. Ideally, the sphere shape, which is then sent to the decoder, should have little to no information about the shape of the original mesh. For some embodiments, the SphereNet process may be an alternation between FaceConv and Face2Node layers without up- or down-sampling. The SphereNet process may be pretrained with base mesh examples and supervising the process with a chamfer loss with random point clouds sampled from a unit sphere. In accordance with some embodiments, the input features are the same as those features described previously with regard to FIG. 5A.

During training of the full architecture, the weights of the SphereNet process are fixed, and the predicted sphere geometry is index-matched with a canonical sphere grid defined by the Fibonacci lattice of the same size as the base mesh geometry. The index-matching is performed using a Sinkhorn algorithm with a Euclidean cost between each pair of 3D points. The indices of the sphere grid corresponding to each of the base mesh geometries are sent to the decoder. This operation ensures that the decoder reconstructs points that lie perfectly on a sphere.

At the decoder, sphere grid points are outputted in the order provided by the indices sent from the encoder. These sphere grid points, along with the latent code and the base mesh connectivity, are initially reconstructed back to the base mesh and a feature map on the base mesh for the heterogeneous mesh decoder (e.g., HetMeshDecoder). The face features on the mesh defined by the sphere grid points and the base mesh connectivity are initialized as described previously. The latent code is concatenated to each of these features. These latent code-augmented face features and mesh are processed by the DeSphereNet block, which is architecturally equivalent to the SphereNet. The output feature map and mesh are sent to the heterogeneous mesh decoder (e.g., HetMeshDecoder).

FIG. 12B is a schematic illustration showing an example index-matching process according to some embodiments. For some embodiments, an index-matching process may be the example Sinkhorn process shown in FIG. 12B. The predicted sphere geometry 1254, which is in the order given by the base mesh geometry 1252, is matched one-to-one with points on a canonical (perfect) sphere lattice. For some embodiments, a Sinkhorn algorithm may be used to compute an approximate minimum-cost bijection between the two sets of points of equal size.

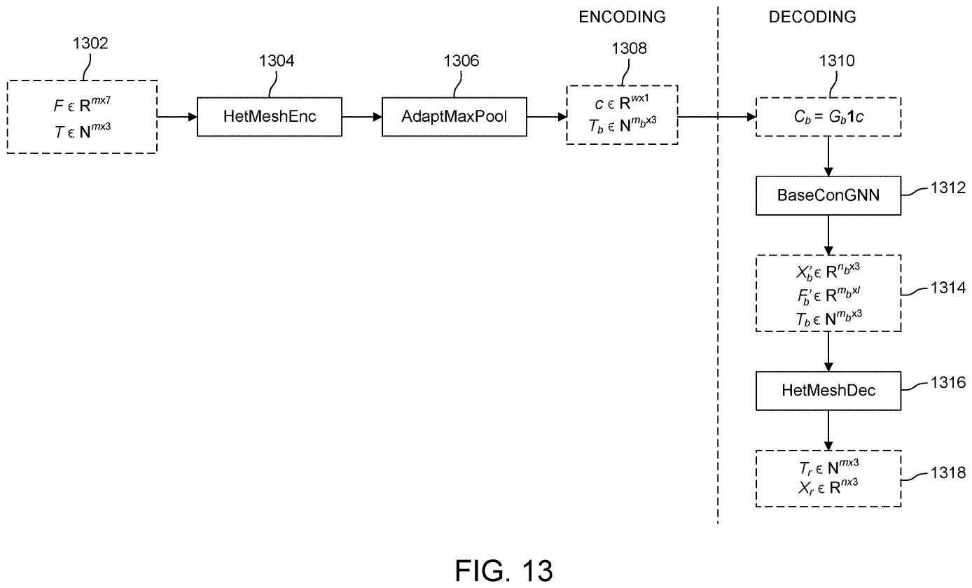

FIG. 13 is a functional block diagram illustrating an example fixed-length codeword autoencoder with hard disentanglement according to some embodiments. For some embodiments, the heterogeneous mesh encoder 1304 encodes the input subdivision mesh 1302. The encoded mesh is passed through an AdaptMaxPool process 1306 to generate a codeword and a list of triangles in a base mesh 1308 for some embodiments.

For some embodiments, the use of matching indices to align an input mesh and a reconstructed mesh may be used only to enforce the loss during training. During inference, the matching indices may be used to re-order the base graph before sending the base graph to the decoder. For some embodiments, the matching indices may not be sent to the decoder, and the decoder may use a SphereNet process to perform (hard) disentanglement.

The example fixed-length codeword autoencoder with hard disentanglement architecture transmits from the encoder to the decoder some information (connectivity+matching indices) in addition to the codeword 1308 to achieve a soft disentanglement. A hard disentanglement may be achieved by transmitting from the encoder to the decoder the codeword (c∈ [symbol] ^{w×1}) and weighted connectivity information (T_{b}∈ [symbol] ^{m}^{_{b}}^{×3}) but no matching index (Iₛ∈ [symbol] ^{m}^{_{b}}^{×3}). The decoder side pipeline is updated accordingly via a graph neural network (GNN)-based block, which may be referred to as Base Mesh Reconstruction GNN (BaseConGNN). See Wu, Zonghan, et al., A Comprehensive Survey on Graph Neural Networks, 32.1 IEEE Transactions on Neural Networks and Learning Systems 4-24 (2020).

A BaseConGNN block 1312 converts a codeword c into a set of local face-specific codewords in which C_{b}=G_{b}1c 1310. These local codewords along with the connectivity information presented as a weighted graph G_{b} from the base mesh connectivity are inputted to a (standard) GNN architecture block. The GNN block makes graph-aware updates through shared MLPs to transform the local codewords into estimated base mesh face features and geometry. The rest of the decoding pipeline remains the same as shown before in FIG. 4A. With an estimate of the base mesh 1314, the heterogeneous mesh decoder 1316 may perform decoding to produce a reconstructed mesh 1318. The example fixed-length codeword autoencoder with hard disentanglement architecture is shown in FIG. 13.

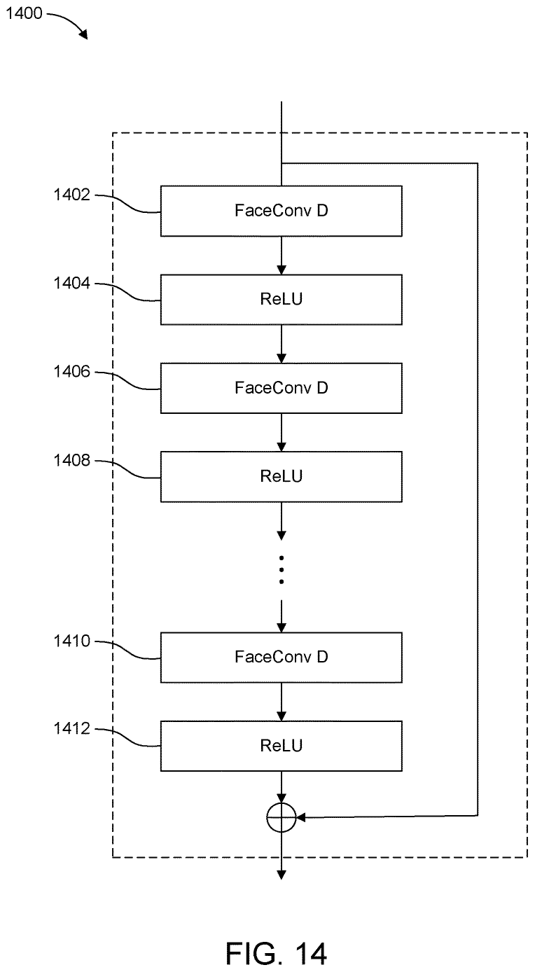

FIG. 14 is a functional block diagram illustrating an example residual face convolution process according to some embodiments. For some embodiments, a residual face convolution process may be the example ResFaceConv process shown in FIG. 14. For some embodiments, the feature aggregation block takes inspiration from a ResNet architecture, as shown in FIG. 14. See He, Kaiming, et al., Deep Residual Learning for Image Recognition, PROCEEDINGS OF THE IEEE CONFERENCE ON COMPUTER VISION AND PATTERN RECOGNITION (2016). This example shows the architecture of a ResFaceConv (RFC) block to aggregate features with D channels. FIG. 14 has a residual connection from the input to add the input to the output of the series of FaceConv D layer 1402, 1406, 1410 and Rectifier Linear Unit (ReLU) block 1404, 1408, 1412 pairs.

A ReLU block refers to a rectifier linear unit function. For example, the ReLU block may output 0 for negative input values and may output the input multiplied by a scalar value for positive input values. In another embodiment, the ReLU function may be replaced by other functions, such as a tanh( ) function and/or a sigmoid( ) function. For some embodiments, the ReLU block may include a nonlinear process in addition to a rectification function.

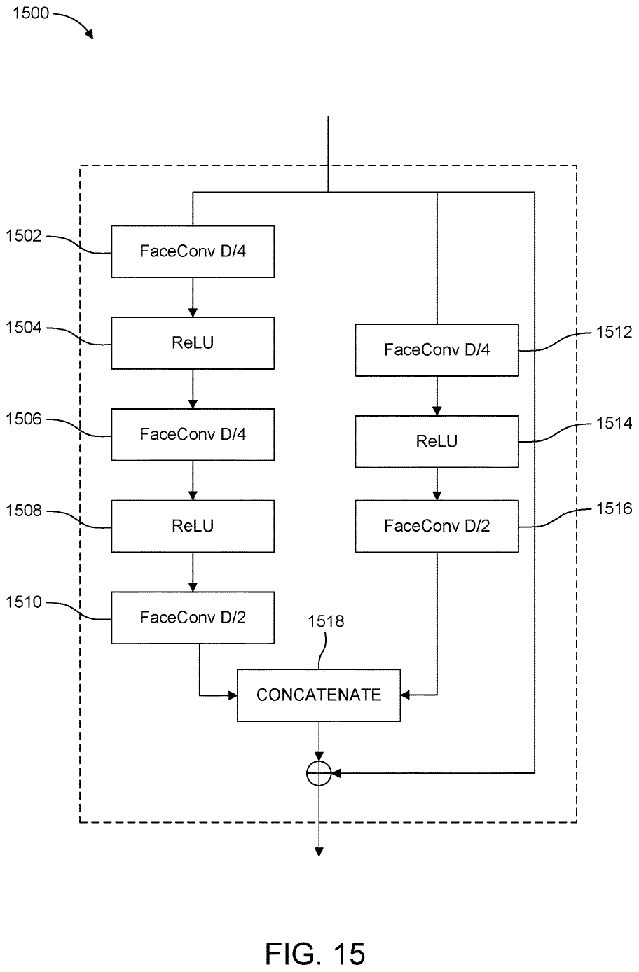

FIG. 15 is a functional block diagram illustrating an example inception-residual face convolution according to some embodiments. For some embodiments, an inception-residual face convolution process may be the example ResFaceConv process shown in FIG. 15. For some embodiments, the feature aggregation block takes inspiration from an Inception-ResNet architecture, as shown in FIG. 15. See Szegedy, Christian, et al., Inception-v4, Inception-ResNet and the Impact of Residual Connections on Learning, THIRTY-FIRST AAAI CONFERENCE ON ARTIFICIAL INTELLIGENCE (2017). This example shows the architecture of an Inception-ResFaceConv (IRFC) block to aggregate features with D channels.

The IRFC block separates the feature aggregation process into three parallel paths. The path with more convolutional layers (the left path in FIG. 15) aggregates (more) global information with a larger receptive field. Such an aggregation of global information may include two sets of a FaceConv D/4 block 1502, 1506 followed by a ReLU block 1504, 1508 for some embodiments. The path with less convolutional layers (the middle path in FIG. 15) aggregates local detailed information with a smaller receptive field. Such an aggregation of local information may include a FaceConv D/4 block 1512 followed by a ReLU block 1514 for some embodiments. The last path (the right path in FIG. 15) is a residual connection which brings the input directly to the output similar to the residual connection in FIG. 14. For some embodiments, a ReLU block may inserted after the FaceConv D/2 block 1510, 1516 and prior to the concatenation 1518 on each of the left and middle paths of FIG. 15.

FIGS. 14 and 15 are example designs of the HetMeshEnc/HetMeshDec shown in, e.g., FIGS. 4A, 5A, and 19.

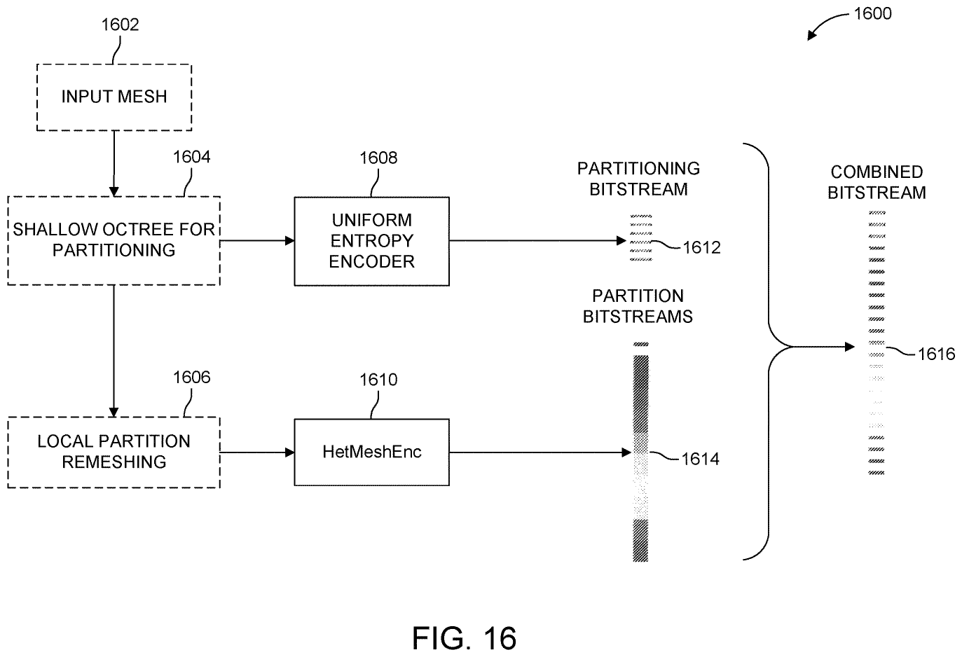

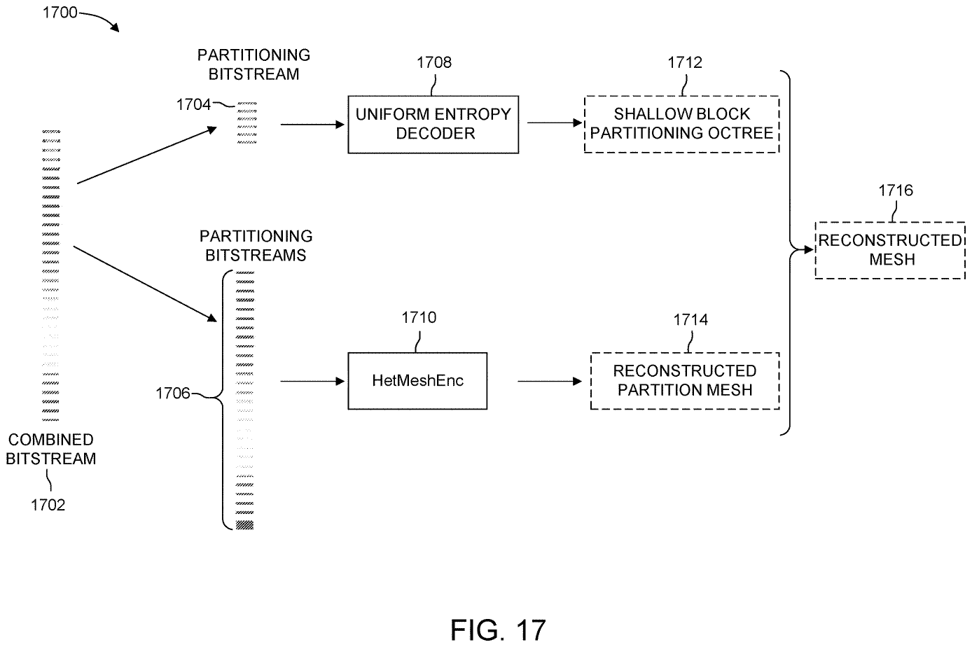

FIG. 16 is a functional block diagram illustrating an example partition-based encoding process according to some embodiments. The architecture described earlier is for encoding and decoding a mesh as whole. However, this procedure may become increasingly time consuming and computationally expensive as the geometry data precision and the density of points in the mesh increases. Moreover, the process of converting the raw mesh data into a re-meshed mesh takes longer as well. To deal with this issue, the raw mesh is converted into partitions.

FIG. 16 shows an input mesh 1602 in the upper left corner. Such an input mesh may be structured similar to the input meshes shown previously, such as the input mesh for FIG. 4A. For some embodiments, the raw input mesh is converted into partitions via a shallow octree process 1604. For each partition, the origin is shifted so that the data points are shifted from the original coordinates to local coordinates for the partition. For some embodiments, this shift may be done as part of a local partition remeshing process 1606. Each partition mesh is encoded separately by a heterogeneous mesh encoder 1610 (e.g., HetMeshEnc) to generate a partition bitstream 1614. Auxiliary information regarding the partitioning by the shallow octree process 1604 is encoded (compressed) using uniform entropy coding 1608. The encoded partitioning bitstream auxiliary information 1612 is added to the partition bitstream 1614 to create the combined bitstream 1616.

Other partitioning schemes, such as object-based or part-based partitioning, may be used for some embodiments. For such embodiments, the shallow octree may be constructed using only the origins of each partition in the original coordinates. With this process, each partition contains a smaller part of the mesh, which may be re-meshed faster and in parallel for each partition. After compression (encoding) and decompression (decoding), the recovered meshes from all partitions are combined and brought back into the original coordinates.

FIG. 17 is a functional block diagram illustrating an example partition-based decoding process according to some embodiments. A combined bitstream input 1702 is shown on the left side of the decoding process 1700 of FIG. 17. The bitstream is split into auxiliary information bits 1704 and mesh partition bits 1706. The mesh partition bits 1706 are decoded using a heterogeneous mesh decoder 1710 (e.g., HetMeshDec) to generate a reconstructed partition mesh 1714. The auxiliary information bits 1704 are decoded (decompressed) using a uniform entropy decoder 1708 and sent to a shallow block partitioning octree process 1712. The shallow block partitioning octree process 1712 combines the reconstructed partition mesh 1714 with the decoded auxiliary information to generate a reconstructed mesh 1716. The decoded auxiliary information includes information regarding the partitioning to enable the shallow block partitioning octree block to generate the reconstructed mesh. For some embodiments, this information may include information indicating the amount to shift a partition to go from local coordinates back to the original coordinates.

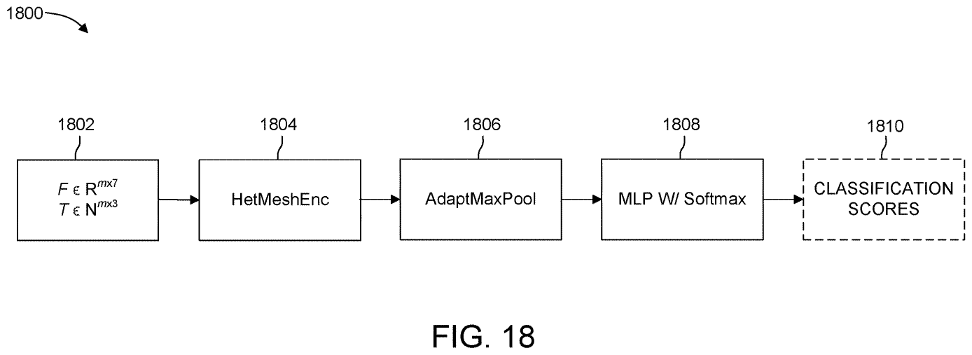

FIG. 18 is a functional block diagram illustrating an example mesh classification architecture based on a fixed-length codeword autoencoder according to some embodiments. FIG. 18 shows an end-to-end learning based mesh encoder framework (e.g., HetMeshEnc), which is a process 1800 which is able to operate on meshes of different sizes and connectivity while producing fixed length latent representations, mimicking those in the image domain. Furthermore, when best reconstruction performance is desired rather than a fixed-length codeword summarizing the global topology of the mesh, encoder and decoder blocks may be adapted to produce and digest (respectively) a latent feature map 1802 residing on a low-resolution base mesh. The codeword produced by HetMeshEnc 1804 followed by an AdaptMaxPool process 1806 is passed through an additional MLP block 1808 whose output dimensions match the number of distinct mesh classes to be classified. The Softmax process 1808 converts the output values into class scores 1810 in the range [0,1]. The class with the highest score is the predicted class for classification.

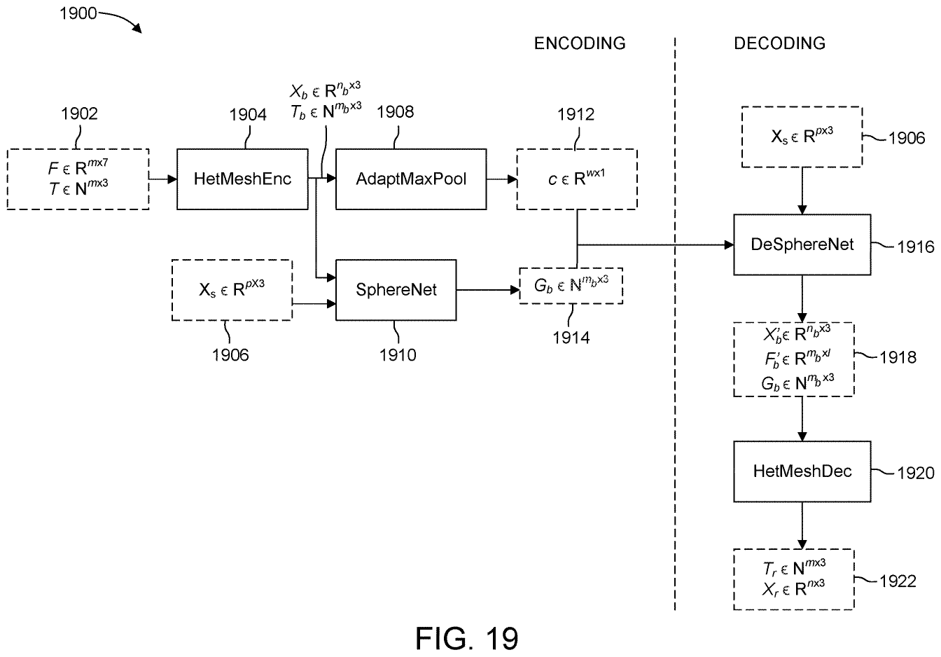

FIG. 19 is a functional block diagram illustrating an example fixed-length codeword autoencoder with soft disentanglement and SphereNet according to some embodiments. For some embodiments, an end-to-end learning-based mesh autoencoder framework HetMeshNet, which is a process 1900 which is able to operate on meshes of different sizes and connectivity while producing useful fixed-length latent representations, may mimic those in the image domain. Furthermore, when best reconstruction performance is desired rather than fixed length codeword summarizing the global topology of the mesh, the proposed encoder and decoder modules can be adapted to produce and digest (respectively) a latent feature map living on a low-resolution base mesh.

The heterogeneous mesh encoder (e.g., HetMeshEnc 1904) encodes the input subdivision mesh 1902 and outputs an initial feature map over the faces of the base mesh. The AdaptMaxPool process 1908 is applied across the faces to generate a latent vector (c∈ [symbol] ^{w×1}) 1912 while also deforming the base mesh into a canonical sphere shape that leads to a base graph (G_{b}∈ [symbol] ^{m}^{_{b}}^{×3} 1914) (also known as base connectivity in this application) using a learnable process (SphereNet 1910) and a list of sampled positions on a unit sphere 1906. For some embodiments, an additional modification request may be found in a heterogeneous mesh encoder.

For decoding, in accordance with some embodiments, the sphere shape and latent vector are first deformed back into a list of positions in the base mesh

$$( {X}_{b}^{′} ∈ {ℝ}^{{n}_{b} \times 3} ) ,$$

a list of features in the base mesh

$$( {F}_{b}^{′} ∈ {ℝ}^{{m}_{b} \times 3} ) ,$$

and the base graph (G_{b}∈ [symbol] ^{m}^{_{b}}^{×3}) 1918 using another learnable process (e.g., DeSphereNet 1916, which may in some embodiments have the same architecture as SphereNet 1910). For some embodiments, DeSphereNet 1916 may use a list of positions on a unit sphere 1906 as an input. DeSphereNet 1916 may include a series of face convolutions and a mesh processing layer, Face2Node. With an estimate of the base mesh and the codeword, the heterogeneous mesh decoder (e.g., HetMeshDec 1920) produces a final reconstructed mesh 1922 at the same resolution as the input subdivision mesh 1902.

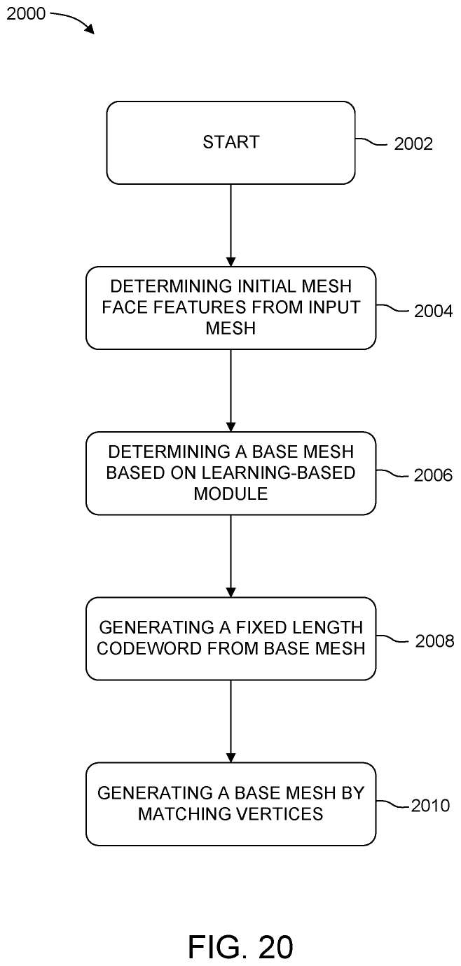

FIG. 20 is a flowchart illustrating an example encoding method according to some embodiments. A process 2000 for encoding mesh data is shown in FIG. 20 for some embodiments. A start bock 2002 is shown, and the process proceeds to block 2004 to determine initial mesh face features from an input mesh. Control proceeds to block 2006 to determine a base mesh comprising a set of face features based on a first learning-based process, which may include a series of mesh feature extraction layers. Control proceeds to block 2008 to generate a fixed length codeword from the base mesh, which may be done using a second learning-based pooling process over the mesh faces. Control proceeds to block 2010 to generate a base graph by matching the vertices of a predefined template mesh and vertices of the base mesh using a third process, which may be a learning-based pooling process.

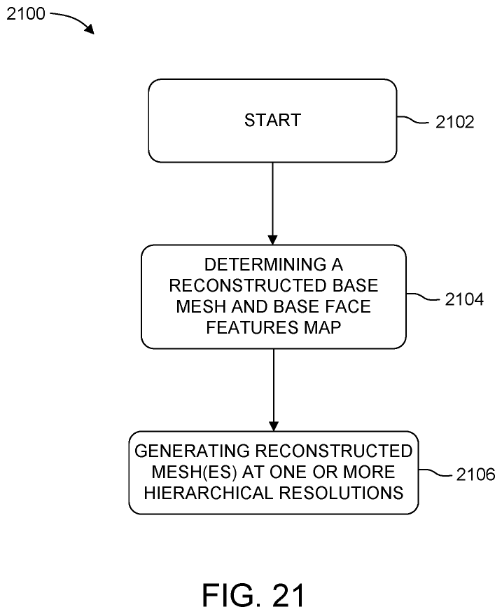

FIG. 21 is a flowchart illustrating an example decoding method according to some embodiments. A process 2100 for decoding mesh data is shown in FIG. 21 for some embodiments. A start block 2102 is shown, and the process proceeds to block 2104 to determine a reconstructed base mesh and base face feature map via a first learning based module using a fixed codeword and base graph in presence of the predefined template mesh for some embodiments. Control proceeds to block 2106 to generate at least one reconstructed mesh at a plurality of hierarchical resolutions through a second learning-based module comprising a series of layers comprising a series of mesh feature extraction and node generation layers for some embodiments.

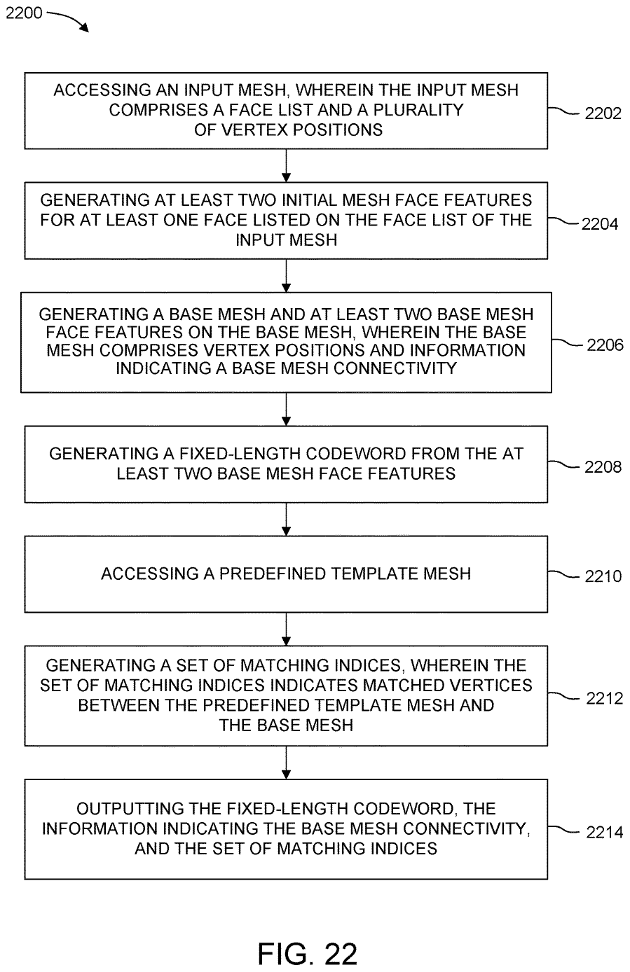

FIG. 22 is a flowchart illustrating an example encoding process according to some embodiments. For some embodiments, an example process may include accessing an input mesh, wherein the input mesh comprises a face list and a plurality of vertex positions. For some embodiments, the example process may further include generating at least two initial mesh face features for at least one face listed on the face list of the input mesh. For some embodiments, the example process may further include generating a base mesh and at least two base mesh face features on the base mesh, wherein the base mesh comprises vertex positions and information indicating a base mesh connectivity. For some embodiments, the example process may further include generating a fixed-length codeword from the at least two base mesh face features. For some embodiments, the example process may further include accessing a predefined template mesh. For some embodiments, the example process may further include generating a set of matching indices, wherein the set of matching indices indicates matched vertices between the predefined template mesh and the base mesh. For some embodiments, the example process may further include outputting the fixed-length codeword, the information indicating the base mesh connectivity, and the set of matching indices.

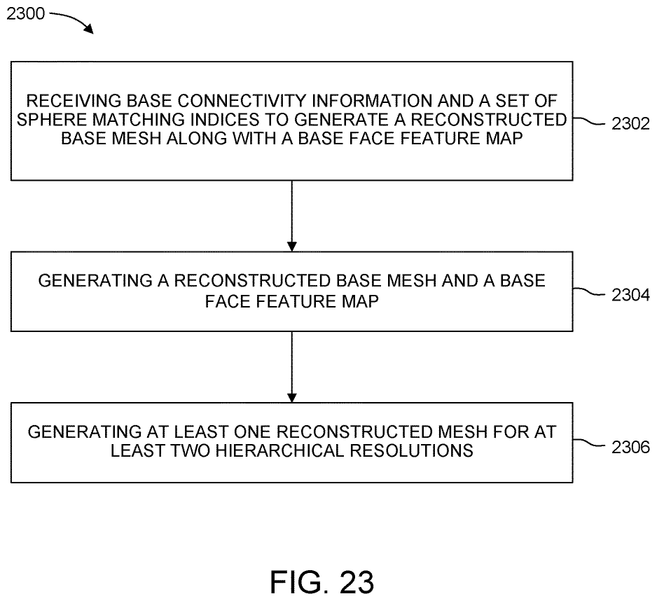

FIG. 23 is a flowchart illustrating an example decoding process according to some embodiments. For some embodiments, an example process may include receiving a fixed-length codeword, information indicating base mesh connectivity, and a set of matching indices to generate a reconstructed base mesh and at least two base face features. For some embodiments, the example process may further include generating a reconstructed base mesh and at least two base face features. For some embodiments, the example process may further include generating at least one reconstructed mesh for at least two hierarchical resolutions.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

A first example method in accordance with some embodiments may include: accessing a semi-regular input mesh to generate an initial mesh face feature for each mesh face, wherein the semi-regular input mesh comprises a face list and a plurality of vertex positions; generating a base mesh comprising vertex positions and information indicating a base connectivity, along with a set of face features on the base mesh, through a learning-based feature aggregation module; generating a fixed-length codeword based on base face features using a feature pooling module; accessing a predefined template mesh and the base mesh to generate a set of matching indices comprising indices of matched vertices between the predefined template mesh and the base mesh; and outputting the generated fixed-length codeword, the information indicating the base connectivity, and the set of matching indices.

A second example method in accordance with some embodiments may include: accessing an input remeshed mesh to generate initial mesh face features, wherein the input remeshed mesh comprises a face list and vertex positions; generating a base mesh along with a set of face features map on the base mesh; generating a fixed length codeword from the base face features; accessing a predefined sphere mesh of predefined number of vertices and base mesh vertices to generate a set of sphere matching indices; and outputting the generated fixed length codeword, base mesh connectivity information, and the set of sphere matching indices.

A third example method in accordance with some embodiments may include: accessing an input mesh, wherein the input mesh comprises a face list and a plurality of vertex positions; generating at least two initial mesh face features for at least one face listed on the face list of the input mesh; generating a base mesh and at least two base mesh face features on the base mesh, wherein the base mesh comprises vertex positions and information indicating a base mesh connectivity; generating a fixed-length codeword from the at least two base mesh face features; accessing a predefined template mesh; generating a set of matching indices, wherein the set of matching indices indicates matched vertices between the predefined template mesh and the base mesh; and outputting the fixed-length codeword, the information indicating the base mesh connectivity, and the set of matching indices.

For some embodiments of the third example method, the input mesh is a semi-regular mesh.

For some embodiments of the third example method, generating the base mesh may include: generating the vertex positions; and generating the information indicating the base mesh connectivity.

For some embodiments of the third example method, generating the at least two base mesh face features on the base mesh is performed through a learning-based aggregation of the at least two initial mesh face features.

For some embodiments of the third example method, generating the fixed-length codeword is performed by pooling of the at least two base mesh face features.

For some embodiments of the third example method, the predefined template mesh is a mesh corresponding to a unit sphere.

For some embodiments of the third example method, the information indicating the base connectivity comprises a list of triangles with information indicating indexing corresponding to matching vertices indicated by the set of matching indices.

For some embodiments of the third example method, generating the base mesh and at least two base mesh face features on the base mesh may be performed by a learning-based heterogeneous mesh encoder, and the heterogeneous mesh encoder may include at least one down-sampling face convolutional layer.

For some embodiments of the third example method, generating the fixed-length codeword from the at least two base mesh face features may include using a learning-based AdaptMaxPool process.

For some embodiments of the third example method, generating the set of matching indices may be performed through a learning-based SphereNet process.

A first example apparatus in accordance with some embodiments may include: a processor; a memory, the memory storing instructions operative, when executed by the processor, to cause the mesh encoder to: access a semi-regular input mesh to generate an initial mesh face feature for each mesh face, wherein the semi-regular input mesh comprises a face list and a plurality of vertex positions; generate a base mesh comprising vertex positions and information indicating a base connectivity, along with a set of face features on the base mesh, through a learning-based feature aggregation module; generate a fixed-length codeword based on base face features using a feature pooling module; access a predefined template mesh and the base mesh to generate a set of matching indices comprising indices of matched vertices between the predefined template mesh and the base mesh; and output the generated fixed-length codeword, the information indicating the base connectivity, and the set of matching indices.

A second example apparatus in accordance with some embodiments may include: a processor; and a memory, the memory storing instructions operative, when executed by the processor, to cause the processor to: access an input remeshed mesh to generate initial mesh face features, wherein the input remeshed mesh comprises a face list and vertex positions; generate a base mesh along with a set of face features map on the base mesh; generate a fixed length codeword from the base face features; access a predefined sphere mesh of predefined number of vertices and base mesh vertices to generate a set of sphere matching indices; and output the generated fixed length codeword, base mesh connectivity information, and the set of sphere matching indices.

A third example apparatus in accordance with some embodiments may include: a processor; a memory, the memory storing instructions operative, when executed by the processor, to cause the mesh encoder to: access an input mesh, wherein the input mesh comprises a face list and a plurality of vertex positions; generate at least two initial mesh face features for at least one face listed on the face list of the input mesh; generate a base mesh and at least two base mesh face features on the base mesh, wherein the base mesh comprises vertex positions and information indicating a base mesh connectivity; generate a fixed-length codeword from the at least two base mesh face features; access a predefined template mesh; generate a set of matching indices, wherein the set of matching indices indicates matched vertices between the predefined template mesh and the base mesh; and output the fixed-length codeword, the information indicating the base mesh connectivity, and the set of matching indices.

A fourth example method in accordance with some embodiments may include: accessing an input mesh; partitioning the input mesh into a first input mesh and a second input mesh, wherein the first input mesh comprises a first face list and a first plurality of vertex positions, and wherein the second input mesh comprises a second face list and a second plurality of vertex positions; generating at least two first initial mesh face features for at least one first face listed on the first face list of the first input mesh; generating a first base mesh and at least two first base mesh face features on the first base mesh, wherein the first base mesh comprises first vertex positions and first information indicating a first base mesh connectivity; generating a first fixed-length codeword from the at least two first base mesh face features; accessing a first predefined template mesh; generating a first set of matching indices, wherein the first set of matching indices indicates first matched vertices between the first predefined template mesh and the first base mesh; and outputting the first fixed-length codeword, the first information indicating the first base mesh connectivity, and the first set of matching indices; generating at least two second initial mesh face features for at least one second face listed on the second face list of the second input mesh; generating a second base mesh and at least two second base mesh face features on the second base mesh, wherein the second base mesh comprises second vertex positions and second information indicating a first base mesh connectivity; generating a second fixed-length codeword from the at least two second base mesh face features; accessing a second predefined template mesh; generating a second set of matching indices, wherein the second set of matching indices indicates second matched vertices between the second predefined template mesh and the second base mesh; and outputting the second fixed-length codeword, the second information indicating the second base mesh connectivity, and the second set of matching indices;

A fifth example method in accordance with some embodiments may include: accessing the base connectivity information and the set of sphere matching indices to generate, through a learning-based module DeSphereNet, a reconstructed base mesh along with a base face feature map; and generating K reconstructed meshes at K hierarchical resolutions through a learning-based module HetMeshDec, consisting of a series of K pairs of UpFaceConv and Face2Node modules.

A sixth example method in accordance with some embodiments may include: accessing base mesh connectivity information, a fixed length codeword, and a set of sphere matching indices to generate, a reconstructed base mesh along with a base face feature map; and generating K reconstructed meshes at K hierarchical resolutions.

A seventh example method in accordance with some embodiments may include: receiving a fixed-length codeword, information indicating base mesh connectivity, and a set of matching indices to generate a reconstructed base mesh and at least two base face features; generating a reconstructed base mesh and at least two base face features; and generating at least one reconstructed mesh for at least two hierarchical resolutions.

For some embodiments of the seventh example method, generating the at least one reconstructed mesh generates K reconstructed meshes for K hierarchical resolutions.

For some embodiments of the seventh example method, generating K reconstructed meshes is generated using a heterogeneous mesh decoder.

For some embodiments of the seventh example method, the heterogeneous mesh decoder performs at least one up-sampling face convolution process and at least one Face2Node process.

For some embodiments of the seventh example method, generating the at least one reconstructed mesh generates at least two reconstructed meshes for at least two respective hierarchical resolutions.

For some embodiments of the seventh example method, generating the reconstructed base mesh may be performed through a learning-based DeSphereNet process.

For some embodiments of the seventh example method, generating the at least one reconstructed mesh for at least two hierarchical resolutions comprises: determining input face features from the base face feature map; generating updated face features corresponding to the input face features; determining an updated differential position for one or more nodes of the reconstructed mesh; and updating a position of one or more nodes of the reconstructed base mesh using the respective updated differential position.

A fifth example apparatus in accordance with some embodiments may include: a processor; a memory, the memory storing instructions operative, when executed by the processor, to cause the mesh decoder to: access the base connectivity information and the set of sphere matching indices to generate, through a learning-based module DeSphereNet, a reconstructed base mesh along with a base face feature map; and generate K reconstructed meshes at K hierarchical resolutions through a learning-based module HetMeshDec, consisting of a series of K pairs of UpFaceConv and Face2Node modules.

A sixth example apparatus in accordance with some embodiments may include: a processor; and a memory, the memory storing instructions operative, when executed by the processor, to cause the processor to: access base mesh connectivity information, a fixed length codeword, and a set of sphere matching indices to generate, a reconstructed base mesh along with a base face feature map; and generate K reconstructed meshes at K hierarchical resolutions.

A seventh example apparatus in accordance with some embodiments may include: a processor; a memory, the memory storing instructions operative, when executed by the processor, to cause the mesh decoder to: receive a fixed-length codeword, information indicating base mesh connectivity, and a set of matching indices to generate a reconstructed base mesh and at least two base face features; generate a reconstructed base mesh and at least two base face features; and generate at least one reconstructed mesh for at least two hierarchical resolutions.

An eighth example apparatus in accordance with some embodiments may include: a mesh decoder configured to take a fixed length codeword, base connectivity information, and a set of sphere matching indices, and to generate a reconstructed mesh, wherein the mesh decoder is configured to: access the base connectivity information and the set of sphere matching indices to generate, through a learning-based module DeSphereNet, a reconstructed base mesh along with a base face feature map; and generate K reconstructed meshes at K hierarchical resolutions through a learning-based module HetMeshDec, consisting of a series of K pairs of UpFaceConv and Face2Node modules.

A first example method in accordance with some embodiments may include: accessing a semi-regular input mesh to generate an initial mesh face feature for each mesh face, wherein the semi-regular input mesh comprises a face list and a plurality of vertex positions; generating a base mesh comprising vertex positions and information indicating a base connectivity, along with a set of face features on the base mesh, through a learning-based feature aggregation module; generating a fixed-length codeword based on base face features using a feature pooling module; accessing a predefined template mesh and the base mesh to generate information indicating matched vertices between the predefined template mesh and the base mesh; and outputting the generated fixed-length codeword and the information indicating the base connectivity.

A second example method in accordance with some embodiments may include: accessing an input remeshed mesh to generate initial mesh face features, wherein the input remeshed mesh comprises a face list and vertex positions; generating a base mesh along with a set of face features map on the base mesh; generating a fixed length codeword from the base face features; accessing a predefined sphere mesh of predefined number of vertices and base mesh vertices to generate a matching between the sphere mesh vertices and the base mesh vertices; and outputting the generated fixed length codeword and base mesh connectivity information.

A third example method in accordance with some embodiments may include: accessing an input mesh, wherein the input mesh comprises a face list and a plurality of vertex positions; generating at least two initial mesh face features for at least one face listed on the face list of the input mesh; generating a base mesh and at least two base mesh face features on the base mesh, wherein the base mesh comprises vertex positions and information indicating a base mesh connectivity; generating a fixed-length codeword from the at least two base mesh face features; accessing a predefined template mesh; generating information indicating matched vertices between the predefined template mesh and the base mesh; and outputting the fixed-length codeword and the information indicating the base mesh connectivity.

For some embodiments of the third example method, the input mesh is a semi-regular mesh.

For some embodiments of the third example method, generating the base mesh may include: generating the vertex positions; and generating the information indicating the base mesh connectivity.

For some embodiments of the third example method, generating the at least two base mesh face features on the base mesh is performed through a learning-based aggregation of the at least two initial mesh face features.

For some embodiments of the third example method, generating the fixed-length codeword is performed by pooling of the at least two base mesh face features.

For some embodiments of the third example method, the predefined template mesh is a mesh corresponding to a unit sphere.

For some embodiments of the third example method, the information indicating the base connectivity comprises a list of triangles with information indicating indexing corresponding to matching vertices indicated by the set of matching indices.

For some embodiments of the third example method, generating the base mesh and at least two base mesh face features on the base mesh is performed by a learning-based heterogeneous mesh encoder, and the heterogeneous mesh encoder comprises at least one down-sampling face convolutional layer.

For some embodiments of the third example method, generating the fixed-length codeword from the at least two base mesh face features comprises using a learning-based AdaptMaxPool process.

For some embodiments of the third example method, generating the set of matching indices is performed through a learning-based SphereNet process.

Some embodiments of the third example method may further include: outputting the information indicating matched vertices, wherein the information indicating matched vertices comprises a set of matching indices indicating matched vertices between the predefined template mesh and the base mesh.

A first example apparatus in accordance with some embodiments may include: a processor; a memory, the memory storing instructions operative, when executed by the processor, to cause the mesh encoder to: access a semi-regular input mesh to generate an initial mesh face feature for each mesh face, wherein the semi-regular input mesh comprises a face list and a plurality of vertex positions; generate a base mesh comprising vertex positions and information indicating a base connectivity, along with a set of face features on the base mesh, through a learning-based feature aggregation module; generate a fixed-length codeword based on base face features using a feature pooling module; access a predefined template mesh and the base mesh to generate information indicating matched vertices between the predefined template mesh and the base mesh; and output the generated fixed-length codeword and the information indicating the base connectivity.

A second example apparatus in accordance with some embodiments may include: a processor; and a memory, the memory storing instructions operative, when executed by the processor, to cause the processor to: access an input remeshed mesh to generate initial mesh face features, wherein the input remeshed mesh comprises a face list and vertex positions; generate a base mesh along with a set of face features map on the base mesh; generate a fixed length codeword from the base face features; access a predefined sphere mesh of predefined number of vertices and base mesh vertices to generate matching between the sphere mesh vertices and the base mesh vertices; and output the generated fixed length codeword and base mesh connectivity information.

A third example apparatus in accordance with some embodiments may include: a processor; a memory, the memory storing instructions operative, when executed by the processor, to cause the mesh encoder to: access an input mesh, wherein the input mesh comprises a face list and a plurality of vertex positions; generate at least two initial mesh face features for at least one face listed on the face list of the input mesh; generate a base mesh and at least two base mesh face features on the base mesh, wherein the base mesh comprises vertex positions and information indicating a base mesh connectivity; generate a fixed-length codeword from the at least two base mesh face features; access a predefined template mesh; generate information indicating a matching of vertices between the predefined template mesh and the base mesh; and output the fixed-length codeword and the information indicating the base mesh connectivity.

A fourth example method in accordance with some embodiments may include: accessing a base connectivity information and a predefined sphere mesh to generate, through a learning-based module DeSphereNet, a reconstructed base mesh along with a base face feature map; and generating K reconstructed meshes at K hierarchical resolutions through a learning-based module HetMeshDec, consisting of a series of K pairs of UpFaceConv and Face2Node modules.

A fifth example method in accordance with some embodiments may include: accessing base mesh connectivity information, a fixed length codeword, and a predefined sphere mesh to generate a reconstructed base mesh along with a base face feature map; and generating K reconstructed meshes at K hierarchical resolutions.

A sixth example method in accordance with some embodiments may include: receiving a fixed-length codeword, information indicating base mesh connectivity, and a predefined mesh to generate a reconstructed base mesh and at least two base face features; generating a reconstructed base mesh and at least two base face features; and generating at least one reconstructed mesh for at least two hierarchical resolutions.

For some embodiments of the sixth example method, generating the at least one reconstructed mesh generates K reconstructed meshes for K hierarchical resolutions.

For some embodiments of the sixth example method, generating K reconstructed meshes is generated using a heterogeneous mesh decoder.

For some embodiments of the sixth example method, the heterogeneous mesh decoder performs at least one up-sampling face convolution process and at least one Face2Node process.

For some embodiments of the sixth example method, generating the at least one reconstructed mesh generates at least two reconstructed meshes for at least two respective hierarchical resolutions.

For some embodiments of the sixth example method, generating the reconstructed base mesh is performed through a learning-based DeSphereNet process.

For some embodiments of the sixth example method, generating the at least one reconstructed mesh for at least two hierarchical resolutions comprises: determining input face features from the base face feature map; generating updated face features corresponding to the input face features; determining an updated differential position for one or more nodes of the reconstructed mesh; and updating a position of one or more nodes of the reconstructed base mesh using the respective updated differential position.

A fourth example apparatus in accordance with some embodiments may include: a processor; a memory, the memory storing instructions operative, when executed by the processor, to cause the mesh decoder to: access a base connectivity information and a predefined sphere mesh to generate, through a learning-based module DeSphereNet, a reconstructed base mesh along with a base face feature map; and generate K reconstructed meshes at K hierarchical resolutions through a learning-based module HetMeshDec, consisting of a series of K pairs of UpFaceConv and Face2Node modules.

A fifth example apparatus in accordance with some embodiments may include: a processor; and a memory, the memory storing instructions operative, when executed by the processor, to cause the processor to: access base mesh connectivity information, a fixed length codeword, and a predefined sphere mesh to generate, a reconstructed base mesh along with a base face feature map; and generate K reconstructed meshes at K hierarchical resolutions.

A sixth example apparatus in accordance with some embodiments may include: a processor; a memory, the memory storing instructions operative, when executed by the processor, to cause the mesh decoder to: receive a fixed-length codeword, information indicating base mesh connectivity, and a predefined mesh to generate a reconstructed base mesh and at least two base face features; generate a reconstructed base mesh and at least two base face features; and generate at least one reconstructed mesh for at least two hierarchical resolutions.

An example mesh decoder configured to take a fixed length codeword, base connectivity information, and a set of sphere matching indices, and to generate a reconstructed mesh in accordance with some embodiments may be configured to: access the base connectivity information and the predefined sphere mesh to generate, through a learning-based module DeSphereNet, a reconstructed base mesh along with a base face feature map; and generate K reconstructed meshes at K hierarchical resolutions through a learning-based module HetMeshDec, consisting of a series of K pairs of UpFaceConv and Face2Node modules.

A seventh example method in accordance with some embodiments may include: determining initial mesh face features from an input mesh; determining a base mesh comprising a set of face features based on a first learning-based module, comprising a series of mesh feature extraction layers; generating a fixed length codeword from the base mesh using a second learning-based pooling module over the mesh faces; and, generating a base graph by matching the vertices of a predefined template mesh and vertices of the base mesh using a third module.

A seventh example apparatus in accordance with some embodiments may include: memory and a processor, configured to perform: determining initial mesh face features from an input mesh; determining a base mesh comprising a set of face features based on a first learning-based module, comprising a series of mesh feature extraction layers; generating a fixed length codeword from the base mesh using a second learning-based pooling module over the mesh faces; and, generating a base graph by matching the vertices of a predefined template mesh and vertices of the base mesh using a third module.

An eighth example method in accordance with some embodiments may include: determining a reconstructed base mesh and base face feature map via a first learning based module using a fixed codeword and base graph in presence of the predefined template mesh; generating at least one reconstructed mesh at a plurality of hierarchical resolutions through a second learning-based module comprising a series of layers comprising a series of mesh feature extraction and node generation layers.

An eighth example apparatus in accordance with some embodiments may include: memory and a processor, configured to perform: determining a reconstructed base mesh and base face feature map via a first learning based module using a fixed codeword and base graph in presence of the predefined template mesh; generating at least one reconstructed mesh at a plurality of hierarchical resolutions through a second learning-based module comprising a series of layers comprising a series of mesh feature extraction and node generation layers.

A ninth example apparatus in accordance with some embodiments may include: a heterogeneous mesh encoder comprising a series of layers comprising pairs of a mesh feature extraction module and a mesh downsampling module; and a heterogeneous mesh decoder comprising a learning-based module comprising a series of layers comprising pairs of a mesh node generation module, and a mesh upsampling module.

For some embodiments of the ninth example apparatus, a base mesh is transmitted from the heterogeneous mesh encoder to the heterogeneous mesh decoder.

For some embodiments of the ninth example apparatus, a plurality of input features are used in addition to a mesh directly consumed.

For some embodiments of the eighth example method, said loop subdivision-based upsampling module comprises: constructing a set of augmented node-specific face features; updating said set of augmented node-specific face features using a shared module; averaging the updated node-specific face features; and performing neighborhood averaging on node locations.

Some embodiments of the eighth example method may further include: converting a codeword into a set of face-specific codewords; and transforming the face-specific codewords into base mesh features and geometry.

Some embodiments of the eighth example method may further include: converting a raw mesh into partitions; shifting the origin for said partitions; and, encoding or decoding each partition mesh separately.

For some embodiments of the eighth example method, said meshes are of differing sizes and connectivity.

A tenth example apparatus in accordance with some embodiments may include a non-transitory computer readable medium containing data content generated according to any one of the methods listed above for playback using a processor.

A first example signal in accordance with some embodiments may include: video data generated according to any one of the methods listed above for playback using a processor.

An example computer program product in accordance with some embodiments may include instructions which, when the program is executed by a computer, cause the computer to carry out any one of the methods listed above.

A first non-transitory computer readable medium in accordance with some embodiments may include data content comprising instructions to perform any one of the methods listed above.

For some embodiments of the seventh example apparatus, said third module is a learning based module.

For some embodiments of the seventh example apparatus, said third module is a traditional non-learning based module.

An eleventh example method in accordance with some embodiments may include: accessing an input mesh, wherein the input mesh comprises a face list and a plurality of vertex positions; generating at least two initial mesh face features for at least one face listed on the face list of the input mesh; generating a base mesh and at least two base mesh face features on the base mesh, wherein the base mesh comprises vertex positions and information indicating a base mesh connectivity; accessing a predefined template mesh; generating information indicating matched vertices between the predefined template mesh and the base mesh; and outputting the information indicating the base mesh connectivity.

An eleventh example apparatus in accordance with some embodiments may include: a processor; and a memory, the memory storing instructions operative, when executed by the processor, to cause the processor to: access an input mesh, wherein the input mesh comprises a face list and a plurality of vertex positions; generate at least two initial mesh face features for at least one face listed on the face list of the input mesh; generate a base mesh and at least two base mesh face features on the base mesh, wherein the base mesh comprises vertex positions and information indicating a base mesh connectivity; access a predefined template mesh; generate information indicating matched vertices between the predefined template mesh and the base mesh; and output the information indicating the base mesh connectivity.

A twelfth example method in accordance with some embodiments may include: receiving information indicating base mesh connectivity, and a predefined mesh to generate a reconstructed base mesh and at least two base face features; generating a reconstructed base mesh and at least two base face features; and generating at least one reconstructed mesh for at least two hierarchical resolutions.

A twelfth example apparatus in accordance with some embodiments may include: a processor; and a memory, the memory storing instructions operative, when executed by the processor, to cause the processor to: receive information indicating base mesh connectivity, and a predefined mesh to generate a reconstructed base mesh and at least two base face features; generate a reconstructed base mesh and at least two base face features; and generate at least one reconstructed mesh for at least two hierarchical resolutions.

A thirteenth example method in accordance with some embodiments may include: accessing an input mesh, wherein the input mesh comprises a face list and a plurality of vertex positions; performing a heterogeneous mesh encoder process to generate at least two initial mesh face features for at least one face listed on the face list of the input mesh; performing an AdaptMaxPool process to: generate a base mesh and at least two base mesh face features on the base mesh, wherein the base mesh comprises vertex positions and information indicating a base mesh connectivity; and generate a fixed-length codeword from the at least two base mesh face features; outputting the fixed-length codeword and the information indicating the base mesh connectivity.

A thirteenth example apparatus in accordance with some embodiments may include: a processor; and a memory, the memory storing instructions operative, when executed by the processor, to cause the processor to: access an input mesh, wherein the input mesh comprises a face list and a plurality of vertex positions; perform a heterogeneous mesh encoder process to generate at least two initial mesh face features for at least one face listed on the face list of the input mesh; perform an AdaptMaxPool process to: generate a base mesh and at least two base mesh face features on the base mesh, wherein the base mesh comprises vertex positions and information indicating a base mesh connectivity; and generate a fixed-length codeword from the at least two base mesh face features; outputting the fixed-length codeword and the information indicating the base mesh connectivity.

A fourteenth example method in accordance with some embodiments may include: receiving a fixed-length codeword, information indicating base mesh connectivity, and a predefined mesh to generate a reconstructed base mesh and at least two base face features; performing a Base Mesh Reconstruction Graph Neural Network (BaseConGNN) process to generate a reconstructed base mesh and at least two base face features; and performing a heterogeneous mesh decoder process to generate at least one reconstructed mesh for at least two hierarchical resolutions.

A fourteenth example apparatus in accordance with some embodiments may include: a processor; and a memory, the memory storing instructions operative, when executed by the processor, to cause the processor to: receive a fixed-length codeword, information indicating base mesh connectivity, and a predefined mesh to generate a reconstructed base mesh and at least two base face features; perform a Base Mesh Reconstruction Graph Neural Network (BaseConGNN) process to generate a reconstructed base mesh and at least two base face features; and perform a heterogeneous mesh decoder process to generate at least one reconstructed mesh for at least two hierarchical resolutions.

A fifteenth example method in accordance with some embodiments may include: accessing an input mesh; partitioning the input mesh into a first input mesh and a second input mesh, wherein the first input mesh comprises a first face list and a first plurality of vertex positions, and wherein the second input mesh comprises a second face list and a second plurality of vertex positions; generating at least two first initial mesh face features for at least one first face listed on the first face list of the first input mesh; generating a first base mesh and at least two first base mesh face features on the first base mesh, wherein the first base mesh comprises first vertex positions and first information indicating a first base mesh connectivity; generating a first fixed-length codeword from the at least two first base mesh face features; accessing a first predefined template mesh; outputting the first fixed-length codeword and the first information indicating the first base mesh connectivity; generating at least two second initial mesh face features for at least one second face listed on the second face list of the second input mesh; generating a second base mesh and at least two second base mesh face features on the second base mesh, wherein the second base mesh comprises second vertex positions and second information indicating a first base mesh connectivity; generating a second fixed-length codeword from the at least two second base mesh face features; accessing a second predefined template mesh; and outputting the second fixed-length codeword and the second information indicating the second base mesh connectivity.

Some embodiments of the fifteenth example method may further include: generating a first set of matching indices, wherein the first set of matching indices indicates first matched vertices between the first predefined template mesh and the first base mesh; outputting the first set of matching indices; generating a second set of matching indices, wherein the second set of matching indices indicates second matched vertices between the second predefined template mesh and the second base mesh; and outputting the second set of matching indices.

A fifteenth example apparatus in accordance with some embodiments may include: a processor; and a memory, the memory storing instructions operative, when executed by the processor, to cause the processor to: access an input mesh; partition the input mesh into a first input mesh and a second input mesh, wherein the first input mesh comprises a first face list and a first plurality of vertex positions, and wherein the second input mesh comprises a second face list and a second plurality of vertex positions; generate at least two first initial mesh face features for at least one first face listed on the first face list of the first input mesh; generate a first base mesh and at least two first base mesh face features on the first base mesh, wherein the first base mesh comprises first vertex positions and first information indicating a first base mesh connectivity; generate a first fixed-length codeword from the at least two first base mesh face features; access a first predefined template mesh; output the first fixed-length codeword and the first information indicating the first base mesh connectivity; generate at least two second initial mesh face features for at least one second face listed on the second face list of the second input mesh; generate a second base mesh and at least two second base mesh face features on the second base mesh, wherein the second base mesh comprises second vertex positions and second information indicating a first base mesh connectivity; generate a second fixed-length codeword from the at least two second base mesh face features; access a second predefined template mesh; and output the second fixed-length codeword and the second information indicating the second base mesh connectivity.

A sixteenth example apparatus in accordance with some embodiments may include: at least one processor configured to perform any one of the methods listed above.

A seventeenth example apparatus in accordance with some embodiments may include a computer-readable medium storing instructions for causing one or more processors to perform any one of the methods listed above.

An eighteenth example apparatus in accordance with some embodiments may include: at least one processor and at least one non-transitory computer-readable medium storing instructions for causing the at least one processor to perform any one of the methods listed above.

A second example signal in accordance with some embodiments may include: a bitstream generated according to any one of the methods listed above.

Various implementations involve decoding. “Decoding”, as used in this application, can encompass all or part of the processes performed, for example, on a received encoded sequence to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this application.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this application.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions and is believed to be well understood by those skilled in the art.

Note that the syntax elements used herein are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments may refer to parametric models or rate distortion optimization. In particular, during the encoding process, the balance or trade-off between the rate and distortion is usually considered, often given the constraints of computational complexity. It can be measured through a Rate Distortion Optimization (RDO) metric, or through Least Mean Square (LMS), Mean of Absolute Errors (MAE), or other such measurements. Rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a particular one of a plurality of transforms, coding modes or flags. In this way, in an embodiment the same transform, parameter, or mode is used at both the encoder side and the decoder side. Thus, for example, an encoder can transmit (explicit signaling) a particular parameter to the decoder so that the decoder can use the same particular parameter.

Conversely, if the decoder already has the particular parameter as well as others, then signaling can be used without transmitting (implicit signaling) to simply allow the decoder to know and select the particular parameter.

By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skilled in the art, implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

The preceding sections describe a number of embodiments, across various claim categories and types. Features of these embodiments can be provided alone or in any combination. Further, embodiments can include one or more of the following features, devices, or aspects, alone or in any combination, across various claim categories and types:

One embodiment comprises an apparatus comprising a learning-based heterogeneous mesh autoencoder.

Other embodiments comprise the method for performing learning-based heterogeneous mesh autoencoding.

Other embodiments comprise the above methods and apparatus performing face feature initialization.

Other embodiments comprise the above methods and apparatus performing heterogeneous mesh encoding and/or decoding.

Other embodiments comprise the above methods and apparatus performing soft disentanglement or hard disentanglement.

Other embodiments comprise the above methods and apparatus performing partition-based coding.

One embodiment comprises a bitstream or signal that includes one or more syntax elements to perform the above functions, or variations thereof.

One embodiment comprises a bitstream or signal that includes syntax conveying information generated according to any of the embodiments described.

One embodiment comprises creating and/or transmitting and/or receiving and/or decoding according to any of the embodiments described.

One embodiment comprises a method, process, apparatus, medium storing instructions, medium storing data, or signal according to any of the embodiments described.

One embodiment comprises inserting in the signaling syntax elements that enable the decoder to determine decoding information in a manner corresponding to that used by an encoder.

One embodiment comprises creating and/or transmitting and/or receiving and/or decoding a bitstream or signal that includes one or more of the described syntax elements, or variations thereof.

One embodiment comprises a TV, set-top box, cell phone, tablet, or other electronic device that performs transform method(s) according to any of the embodiments described.

One embodiment comprises a TV, set-top box, cell phone, tablet, or other electronic device that performs transform method(s) determination according to any of the embodiments described, and that displays (e.g., using a monitor, screen, or other type of display) a resulting image.

One embodiment comprises a TV, set-top box, cell phone, tablet, or other electronic device that selects, bandlimits, or tunes (e.g., using a tuner) a channel to receive a signal including an encoded image, and performs transform method(s) according to any of the embodiments described.

One embodiment comprises a TV, set-top box, cell phone, tablet, or other electronic device that receives (e.g., using an antenna) a signal over the air that includes an encoded image, and performs transform method(s).

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor.

Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
accessing an input mesh,
wherein the input mesh comprises a face list and a plurality of vertex positions;
generating at least two initial mesh face features for at least one face listed on the face list of the input mesh;
generating a base mesh and at least two base mesh face features on the base mesh,
wherein the base mesh comprises vertex positions and information indicating a base mesh connectivity;
generating a fixed-length codeword from the at least two base mesh face features;
accessing a predefined template mesh;
generating information indicating matched vertices between the predefined template mesh and the base mesh; and
outputting the fixed-length codeword and the information indicating the base mesh connectivity.

2. The method of claim 1, wherein the input mesh is a semi-regular mesh.

3. (canceled)

4. The method of claim 1, wherein generating the at least two base mesh face features on the base mesh is performed through a learning-based aggregation of the at least two initial mesh face features.

5. The method of claim 1, wherein generating the fixed-length codeword is performed by pooling of the at least two base mesh face features.

6. The method of claim 1, wherein the predefined template mesh is a mesh corresponding to a unit sphere.

7. The method of claim 1, wherein the information indicating the base connectivity comprises a list of triangles with information indicating indexing corresponding to the matched vertices.

8. The method of claim 1,
wherein generating the base mesh and at least two base mesh face features on the base mesh is performed by a learning-based heterogeneous mesh encoder, and
wherein the heterogeneous mesh encoder comprises at least one down-sampling face convolutional layer.

9. The method of claim 1, wherein generating the fixed-length codeword from the at least two base mesh face features comprises using a learning-based AdaptMaxPool process.

10. (canceled)

11. The method of claim 1, further comprising:
outputting, in addition to the fixed-length codeword and the information indicating the base mesh connectivity, the information indicating matched vertices.

12. A device comprising:
a processor;
a memory, the memory storing instructions operative, when executed by the processor, to cause the device to:
access an input mesh,
wherein the input mesh comprises a face list and a plurality of vertex positions;
generate at least two initial mesh face features for at least one face listed on the face list of the input mesh;
generate a base mesh and at least two base mesh face features on the base mesh,
wherein the base mesh comprises vertex positions and information indicating a base mesh connectivity;
generate a fixed-length codeword from the at least two base mesh face features;
access a predefined template mesh;
generate information indicating matched vertices between the predefined template mesh and the base mesh; and
output the fixed-length codeword and the information indicating the base mesh connectivity.

13. A method comprising:
receiving a fixed-length codeword, information indicating base mesh connectivity, and a predefined mesh to generate a reconstructed base mesh and at least two base face features;
generating a reconstructed base mesh and at least two base face features; and
generating at least one reconstructed mesh for at least two hierarchical resolutions.

14. The method of claim 13, wherein generating the at least one reconstructed mesh generates K reconstructed meshes for K hierarchical resolutions.

15. The method of claim 14, wherein generating K reconstructed meshes is generated using a heterogeneous mesh decoder.

16. The method of claim 15, wherein the heterogeneous mesh decoder performs at least one up-sampling face convolution process and at least one Face2Node process.

17. The method of claim 13, wherein generating the at least one reconstructed mesh generates at least two reconstructed meshes for at least two respective hierarchical resolutions.

18. The method of claim 13, wherein generating the reconstructed base mesh is performed through a learning-based DeSphereNet process.

19. The method of claim 13, wherein generating the at least one reconstructed mesh for at least two hierarchical resolutions comprises:
determining input face features from the base face feature map;
generating updated face features corresponding to the input face features;
determining an updated differential position for one or more nodes of the reconstructed mesh; and
updating a position of one or more nodes of the reconstructed base mesh using the respective updated differential position.

20-61. (canceled)

62. The method of claim 1, wherein generating the set of matching indices is performed through a learning-based SphereNet process.

63. The method of claim 1, wherein generating the information indicating the matched vertices comprises generating a set of matching indices indicating the matched vertices.
